(19) United States
(12) Patent Application Publication
(10) Pub. No.: US 2026/0016726 A1
(43) Pub. Date: Jan. 15, 2026

(54) WIRING SUBSTRATE, DISPLAY DEVICE, AND METHOD OF MANUFACTURING THE WIRING SUBSTRATE

(71) Applicant: Sharp Display Technology Corporation, Kameyama City (JP)

(72) Inventor: Taichi SASAKI, Kameyama City (JP)

(21) Appl. No.: 19/331,113

(22) Filed: Sep. 17, 2025

(30) Foreign Application Priority Data
Jul. 9, 2024 (JP) 2024-159909

(51) Int. Cl. G02F 1/1362; G02F 1/1368

(52) U.S. Cl. CPC G02F 1/136295; G02F 1/136209; G02F 1/136254; G02F 1/1368

(57) ABSTRACT

A wiring substrate includes a first wiring line configured to prove a common potential, a second wiring line disposed to be spaced apart from the first wiring line, and a connection portion connected to each of the first wiring line and the second wiring line. The connection portion includes a material whose electrical resistance changes with temperature.

### BACKGROUND

### 1. Field

Technology disclosed in this specification relates to a wiring substrate with reduced charge build-up, a display device, and a method of manufacturing the wiring substrate.

### 2. Description of the Related Art

As an example of wiring substrates, a wiring substrate described in Japanese Unexamined Patent Application Publication No. 2011-232539 is known. Japanese Unexamined Patent Application Publication No. 2011-232539 describes an electronic device that includes a plurality of switching elements provided on an insulating substrate as a wiring substrate. The electronic device described in Japanese Unexamined Patent Application Publication No. 2011-232539 includes a plurality of scanning lines, a plurality of signal lines intersecting the plurality of scanning lines, a plurality of switching elements each provided at corresponding intersections of the plurality of scanning lines and the plurality of signal lines, and a common connection member connected to the plurality of scanning lines and the plurality of signal lines outside a switching element mounting area in which the plurality of switching elements are disposed, the common connection member composed of a material having a variable specific resistance.

In the electronic device described in Japanese Unexamined Patent Application Publication No. 2011-232539, light is irradiated onto a common wiring line, which is the common connection member, to reduce the resistance of the common wiring line, thereby protecting the scanning lines and signal lines connected to the common wiring line from static electricity. However, in the electronic device described in Japanese Unexamined Patent Application Publication No. 2011-232539, if charge accumulation, or charge build-up, occurs in any of a plurality of pixel electrodes connected to the signal lines via the switching elements, a display defect called flicker may become visible.

The technology described in this specification has been made under the above-described circumstances, and made to suppress the occurrence of charge build-up.

### SUMMARY

(1) A wiring substrate according to the technology described in this specification includes a first wiring line configured to prove a common potential, a second wiring line disposed to be spaced apart from the first wiring line, and a connection portion connected to each of the first wiring line and the second wiring line. The connection portion includes a material whose electrical resistance changes with temperature.
(2) A display device according to the technology described in this specification includes the wiring substrate according the (1), and an opposite substrate disposed to face the wiring substrate with a space therebetween.
(3) A method of manufacturing a wiring substrate according to the technology described in this specification includes providing a first wiring line configured to prove a common potential, a second wiring line disposed to be spaced apart from the first wiring line, and a connection portion connected to each of the first wiring line and the second wiring line, the connection portion including a material whose electrical resistance changes with temperature, and performing an annealing process to lower the resistance of the connection portion.

### BRIEF DESCRIPTION OF THE DRAWINGS

FIG. 1 is a plan view of a liquid crystal panel, a driver, and a flexible substrate according to a first embodiment;

FIG. 2 is a cross-sectional view of the liquid crystal panel, the driver, and the flexible substrate according to the first embodiment;

FIG. 3 is a circuit diagram of an electric structure of an array substrate in the liquid crystal panel according to the first embodiment;

FIG. 4 is a circuit diagram illustrating a connection configuration of wiring lines, terminal portions, TFTs, and other elements provided on the array substrate according to the first embodiment;

FIG. 5 is a cross-sectional view illustrating a cross-sectional structure of an inspection TFT provided in the array substrate according to the first embodiment;

FIG. 6 is a plan view illustrating a common wiring line, a common terminal portion, inspection signal wiring lines, inspection signal terminal portions, and a connection portion according to the first embodiment;

FIG. 7 is a cross-sectional view of the array substrate according to the first embodiment taken along line vii-vii in FIG. 6;

FIG. 8 is a flowchart illustrating each process in a method of manufacturing the array substrate according to the first embodiment;

FIG. 9 is a graph illustrating signal waveforms of a first inspection signal and a second inspection signal according to the first embodiment;

FIG. 10 is a plan view illustrating a common wiring line, a common terminal portion, inspection signal wiring lines, inspection signal terminal portions, a connection portion, and a light-shielding portion according to a second embodiment;

FIG. 11 is a cross-sectional view of the array substrate according to the second embodiment taken along line xi-xi in FIG. 10;

FIG. 12 is a cross-sectional view of the array substrate according to the second embodiment taken along line xii-xii in FIG. 10;

FIG. 13 is a plan view illustrating a common wiring line, a common terminal portion, inspection signal wiring lines, inspection signal terminal portions, connection portions, and a light-shielding portion according to a third embodiment; and

FIG. 14 is a cross-sectional view of the array substrate according to the third embodiment taken along line xiv-xiv in FIG. 13.

### DESCRIPTION OF THE EMBODIMENTS

### First Embodiment

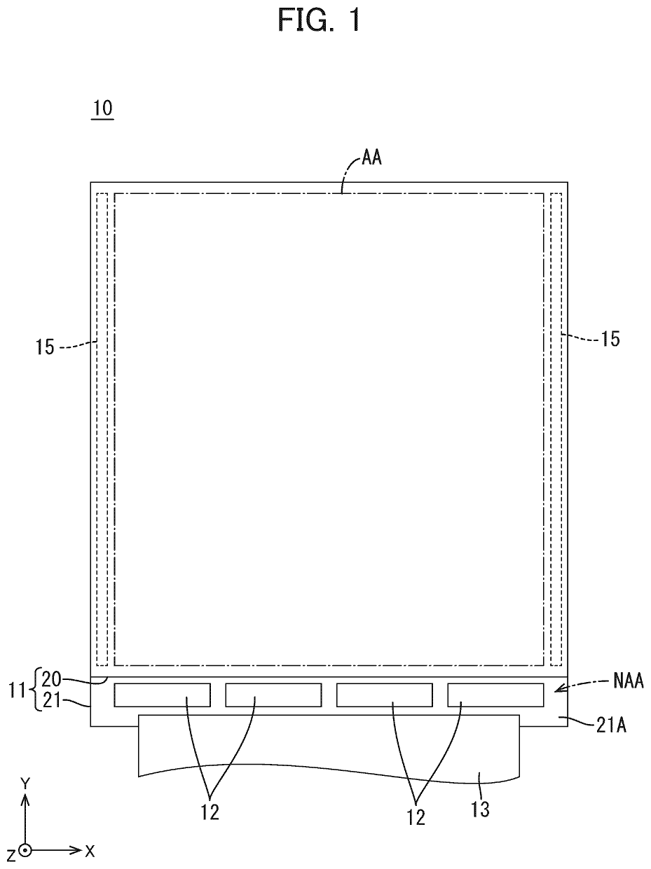

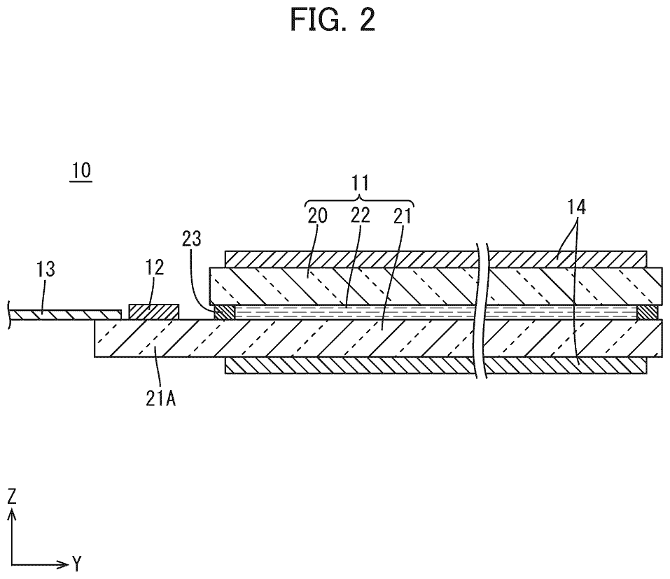

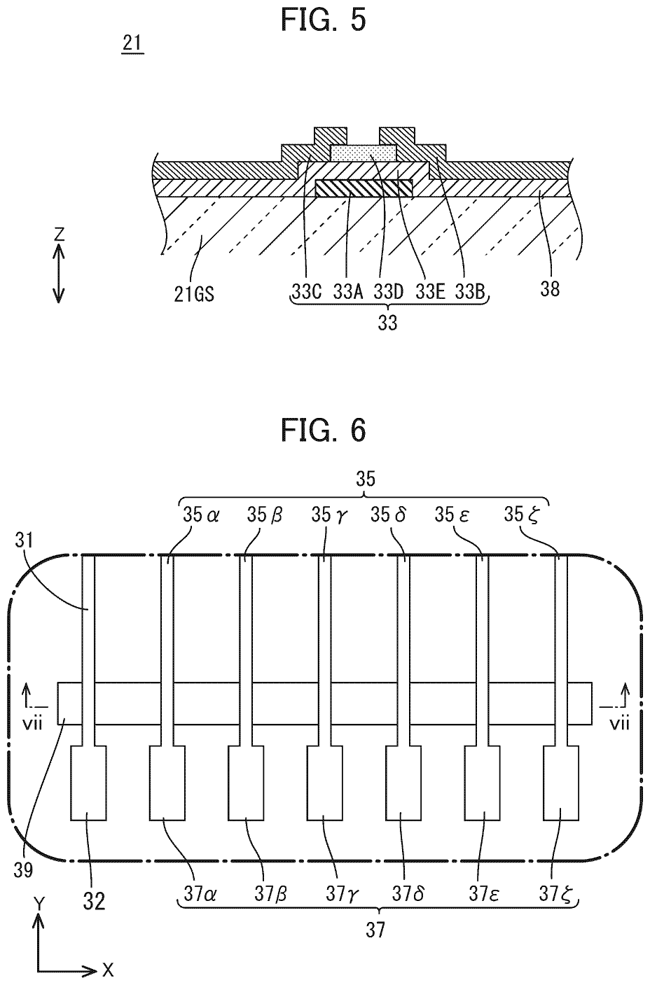

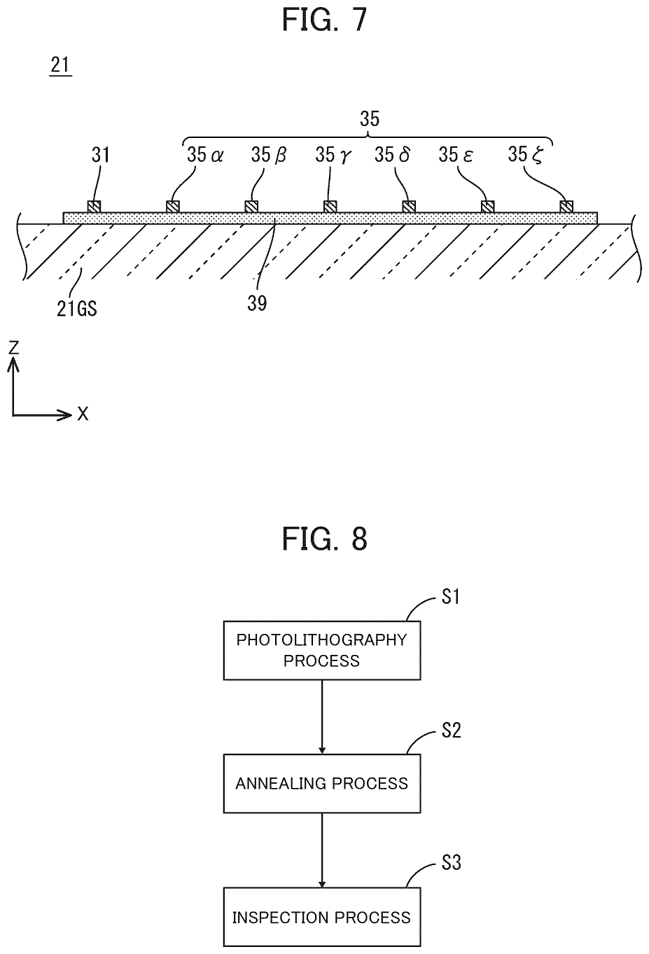

The first embodiment will be described with reference to FIG. 1 to FIG. 9. In this embodiment, a liquid crystal display device 10 will be described as an example. The X-axis, Y-axis, and Z-axis are shown in some of the drawings, and each axis direction corresponds to the direction indicated in each drawing. In FIG. 2, FIG. 5, and FIG. 7, the upper side denotes the front side and the lower side denotes the rear side.

The liquid crystal display device 10 includes, as illustrated in FIG. 1, at least a liquid crystal panel (display device, display panel) 11 that has a horizontally elongated rectangular shape and is configured to display images, and a backlight device (illumination device) that emits light used for display to the liquid crystal panel 11. The backlight device is disposed on the rear side (back side) with respect to the liquid crystal panel 11, and includes a light source (e.g., an LED) that emits white light and an optical element and other elements that apply an optical effect to the light from the light source to convert the light into planar light. In the liquid crystal panel 11, a display area AA is a central portion of a main surface in which images are displayed. In the liquid crystal panel 11, a non-display area NAA is a frame-shaped outer peripheral portion surrounding the display area AA in the main surface, and images are not displayed in the non-display area NAA.

The liquid crystal panel 11 will be described with reference to FIG. 2 in addition to FIG. 1. The liquid crystal panel 11 includes a pair of substrates 20 and 21 that are bonded as illustrated in FIG. 1 and FIG. 2. Of the pair of substrates 20 and 21, the front side is an opposite substrate 20, and the rear side is an array substrate (wiring substrate) 21. Each of the opposite substrate 20 and the array substrate 21 is formed by laminating various films on an inner surface side of a glass substrate. Between the pair of substrates 20 and 21, a liquid crystal layer 22 that contains liquid crystal molecules, which are substances whose optical properties change in response to the application of an electric field, is provided. Between the outer peripheral end portions of the pair of substrates 20 and 21, a sealing member 23 that seals the liquid crystal layer 22 is provided. The sealing member 23 has a rectangular frame shape to surround the liquid crystal layer 22. On the outer surface side of each of the substrates 20 and 21, a polarizing plate 14 is bonded.

The opposite substrate 20 has a long side dimension that is shorter than a long side dimension of the array substrate 21, as illustrated in FIG. 1 and FIG. 2. The opposite substrate 20 is bonded such that one end portion in long side direction (Y-axis direction) is aligned with respect to the array substrate 21. Accordingly, the other end portion of the array substrate 21 in the long side direction protrudes longitudinally with respect to the opposite substrate 20 and is exposed, and the other end portion is referred to as an exposed portion 21A. The entire of the exposed portion 21A is the non-display area NAA, and on which a driver (signal supply unit) 12 and a flexible substrate 13 for supplying various signals are mounted.

The driver 12 comprises an LSI chip that includes an internal drive circuit. The driver 12 is mounted on the exposed portion 21A of the array substrate 21 by Chip On Glass (COG) mounting. The driver 12 processes various signals that are transmitted via the flexible substrate 13. The driver 12 is disposed to be adjacent to the display area AA on one side in the Y-axis direction as illustrated in FIG. 1 and FIG. 2, and is disposed between the flexible substrate 13, which will be described below, and the display area AA. The driver 12 has a horizontally elongated rectangular shape in plan view. The driver 12 comprises a plurality of drivers 12 (for example, four drivers in FIG. 1) that are disposed in line in the X-axis direction with a space therebetween. Each driver 12 is capable of supplying various signals to a source wiring line 27 and other elements that are provided on the array substrate 21. The flexible substrate 13 has a structure in which a plurality of wiring patterns are formed on a base material comprising a synthetic resin material (e.g., a polyimide resin) having insulating properties and flexibility. The flexible substrate 13 is connected at one end to the exposed portion 21A of the array substrate 21 and at the other end to an external circuit board (e.g., a control board).

In the non-display area NAA of the array substrate 21, as illustrated in FIG. 1, a gate drive circuit 15 is provided. The gate drive circuit 15 comprises a pair of gate drive circuits 15 provided on both sides of the display area AA in the X-axis direction with the display area AA therebetween. Each of the gate drive circuits 15 is provided in a long band-shaped area extending in a long side direction (Y-axis direction) of the array substrate 21. The gate drive circuits 15 are used to supply scanning signals to gate wiring lines 26, which will be described below, and are monolithically formed on the array substrate 21. The scanning signals have a potential higher than a threshold voltage of pixel TFTs 24, which will be described below.

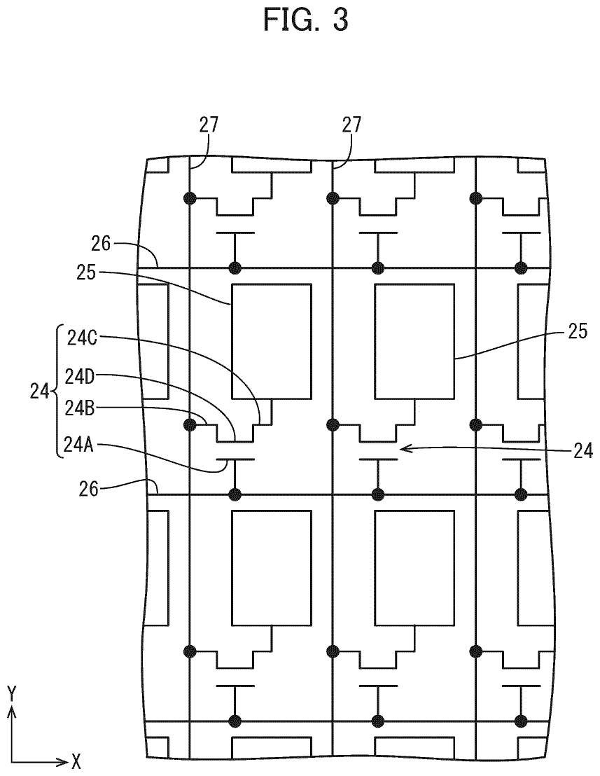

Next, the structure of the display area AA in the array substrate 21 is described with reference to FIG. 3. On the inner surface (surface opposite to the opposite substrate 20) side of the array substrate 21 in the display area AA, as illustrated in FIG. 3, at least the pixel TFTs (transistors, switching elements) 24 and pixel electrodes 25 are provided. The plurality of pixel TFTs 24 and the plurality of pixel electrodes 25 are spaced apart in the X-axis direction and in the Y-axis direction in a matrix (rows and columns) pattern. Around these pixel TFTs 24 and pixel electrodes 25, the gate wiring lines (scanning lines) 26 and source wiring lines (image lines, signal lines) 27 that are orthogonal to each other (intersect) are provided. The plurality of gate wiring lines 26 extend in the X-axis direction (first direction), and are spaced apart in the Y-axis direction. The plurality of source wiring lines 27 extend generally in the Y-axis direction (second direction), and are spaced apart in the X-axis direction.

The pixel TFT 24 includes a first gate electrode 24A that is connected to the gate wiring line 26, a first source electrode 24B that is connected to the source wiring line 27, a first drain electrode 24C that is connected to the pixel electrode 25, and a first semiconductor portion 24D that is connected to the first source electrode 24B and the first drain electrode 24C, as illustrated in FIG. 3. The pixel TFT 24 is driven based on a scanning signal supplied to the first gate electrode 24A via the gate wiring line 26, and a channel region is generated in the first semiconductor portion 24D. This scanning signal has a potential higher than a threshold voltage of the pixel TFT 24. The potential corresponding to an image signal supplied to the first source electrode 24B via the source wiring line 27 is supplied to the first drain electrode 24C via the channel region generated in the first semiconductor portion 24D. As a result, the pixel electrode 25 is charged to the potential corresponding to the image signal. The pixel electrode 25 is disposed in an area surrounded by two adjacent gate wiring lines 26 with a space in the Y-axis direction and two adjacent source wiring lines 27 with a space in the X-axis direction. The pixel electrode 25 comprises a transparent electrode material (e.g., an indium tin oxide (ITO), an indium zinc oxide (IZO), or the like), and has a vertically elongated substantially rectangular shape with the long side direction aligned with the Y-axis direction.

In the display area AA of the opposite substrate 20, a plurality of color filters are disposed at positions facing the pixel electrodes 25 on the array substrate 21 side. The color filters have three colors of R (red), G (green), and B (blue), and are arranged and repeated in a predetermined order in the X-axis direction. The color filters provide pixels of respective colors (red pixels, green pixels, and blue pixels) together with the pixel electrodes 25. These three pixels of the red pixels, green pixels, and blue pixels provide display pixels that enable color display of predetermined gradation. A black matrix is provided between the color filters to prevent color mixing. On each of the innermost surfaces (uppermost layers) of the substrates 20 and 21 that are in contact with the liquid crystal layer 22, an alignment film (not illustrated) is formed to align the liquid crystal molecules contained in the liquid crystal layer 22.

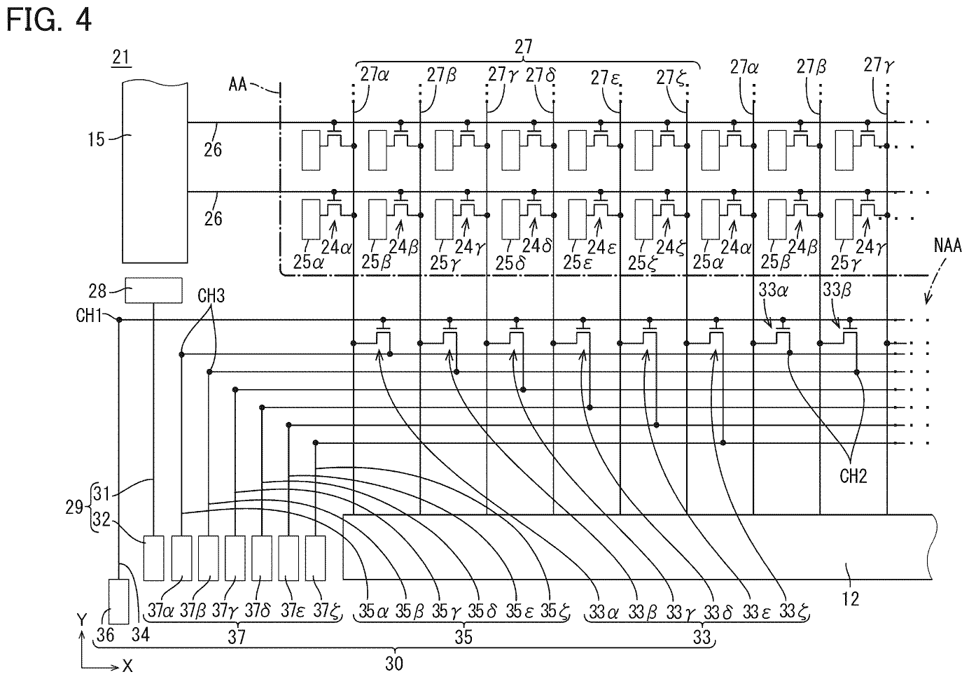

On the opposite substrate 20 or the array substrate 21, as illustrated in FIG. 4, a common electrode 28 that comprises a transparent electrode material similar to that of the pixel electrode 25 and overlaps the pixel electrode 25 with a space therebetween is disposed. To the common electrode 28, a common potential (reference potential) is supplied. The liquid crystal panel 11 is configured such that a predetermined electric field is applied to the liquid crystal layer 22 according to a potential difference between the common electrode 28 and each pixel electrode 25 to cause each pixel to display with a predetermined gradation. When the common electrode 28 is provided in the array substrate 21, an insulating film is provided between the common electrode 28 and each pixel electrode 25, and a slit is provided for the common electrode 28 or the pixel electrode 25 that is located on an upper layer side (liquid crystal layer 22 side). In such a structure, the electric field generated according to the potential difference between the common electrode 28 and the pixel electrode 25 includes a fringe electric field that contains a component in the normal direction to the main surface of the array substrate 21 in addition to a component along the main surface of the array substrate 21. Accordingly, the display mode of the liquid crystal panel 11 having such a structure is a so-called fringe field switching (FFS) mode, which controls the orientation state of the liquid crystals contained in the liquid crystal layer 22 by using the fringe electric field.

Next, the structure of the non-display area NAA in the array substrate 21 is described with reference to FIG. 4 to FIG. 7. On the inner surface side of the array substrate 21 in the non-display area NAA, as illustrated in FIG. 4, in addition to the gate drive circuit 15, lead portions of the gate wiring lines 26 and lead portions of the source wiring lines 27 are provided. The lead portions of the gate wiring lines 26 extend from portions of the gate wiring lines 26 in the display area AA to the gate drive circuit 15 side in the X-axis direction and are connected to the gate drive circuit 15. The lead portions of the source wiring lines 27 extend from portions of the source wiring lines 27 in the display area AA to the driver 12 side in the Y-axis direction and are connected to the driver 12. It should be noted that some of the plurality of lead portions of the gate wiring lines 26 and the plurality of lead portions of the source wiring lines 27 may extend in diagonal directions relative to the X-axis direction and the Y-axis direction.

In addition, on the inner surface side of the array substrate 21 in the non-display area NAA, as illustrated in FIG. 4, a common potential supplying circuit 29 that supplies a common potential to the common electrode 28, and an inspection circuit 30 that inspects the pixel TFTs 24, the source wiring lines 27, and other elements are provided. The common potential supplying circuit 29 and the inspection circuit 30 are disposed in each of two corner portions in the exposed portion 21A of the array substrate 21 (see FIG. 1). The common potential supplying circuit 29 includes a common wiring line (first wiring line) 31 and a common terminal portion 32. The common wiring line 31 is connected to the common terminal portion 32 at one end and to the common electrode 28 at the other end. The common wiring line 31 has a portion that extends in the Y-axis direction. The common terminal portion 32 is disposed in the exposed portion 21A of the array substrate 21. The common terminal portion 32 may be disposed at a portion of the exposed portion 21A where the flexible substrate 13 is mounted. In such a case, the common terminal portion 32 is connected to the flexible substrate 13 and a common potential is supplied via an external circuit board. It should be noted that the common terminal portion 32 may be disposed at a portion of the exposed portion 21A where the common terminal portion 32 does not overlap the flexible substrate 13.

The inspection circuit 30 includes, as illustrated in FIG. 4, an inspection TFT (transistor, switching element) 33, an inspection drive wiring line 34, an inspection signal wiring line 35, an inspection drive terminal portion 36, and an inspection signal terminal portion 37.

The inspection TFT 33 is disposed between the lead portions of two source wiring lines 27 in the X-axis direction. A plurality of inspection TFTs 33 are arranged in the X-axis direction with a space therebetween, and the number of inspection TFTs 33 is the same as the number of source wiring lines 27. The plurality of inspection TFTs 33 and the lead portions of the plurality of source wiring lines 27 are arranged alternately one by one in the X-axis direction. The inspection TFT 33 includes a second gate electrode (first electrode) 33A that is connected to the inspection drive wiring line 34, a second source electrode (second electrode) 33B that is connected to the inspection signal wiring line 35, a second drain electrode (third electrode) 33C that is connected to the source wiring line 27, and a second semiconductor portion (semiconductor portion) 33D that is connected to the second source electrode 33B and the second drain electrode 33C.

Here, various films that are laminated on the inner surface side of the array substrate 21 will be described with reference to FIG. 5. FIG. 5 is a cross-sectional view illustrating a cross-sectional structure of the inspection TFT 33. The array substrate 21 includes, in order from a glass substrate (substrate) 21GS side, at least a first metal film, a gate insulating film (first insulating film) 38, a semiconductor film, and a second metal film, as illustrated in FIG. 5. Each of the first metal film and the second metal film is a single layer film of a single metal material selected from copper, titanium, aluminum, molybdenum, tungsten, or equivalents thereof, or a laminated film or alloy that comprises different types of metal materials, and has electrical conductivity and light-shielding properties. The gate insulating film 38 comprises an inorganic material such as silicon nitride (SiNₓ), silicon oxide (SiO₂), or equivalents thereof, and is a single layer film or a laminated film. The semiconductor film comprises, for example, an oxide semiconductor material, a semiconductor material such as an amorphous silicon material, or equivalents thereof. On the upper layer side to the second metal film, a transparent electrode film that form the pixel electrode 25 and other layers are provided via an interlayer insulating film or the like.

The second gate electrode 33A of the inspection TFT 33 is a part of the first metal film, as illustrated in FIG. 5. It should be noted that the first metal film also forms the gate wiring lines 26, the first gate electrodes 24A of the pixel TFTs 24, and other elements. The second semiconductor portion 33D of the inspection TFT 33 is a part of the semiconductor film. It should be noted that the semiconductor film also forms the first semiconductor portions 24D of the pixel TFTs 24 and other elements. The second source electrode 33B and the second drain electrode 33C of the inspection TFT 33 are parts of the second metal film. The second drain electrode 33C is connected directly to the source wiring line 27. It should be noted that the second metal film also forms the source wiring lines 27, the first source electrodes 24B and the first drain electrodes 24C of the TFTs 24, the common wiring line 31, and other elements. The inspection TFT 33 includes a second insulating portion 33E between the second gate electrode 33A and the second semiconductor portion 33D. The second insulating portion 33E is a part of the gate insulating film 38. The cross-sectional structure of the inspection TFT 33 illustrated in FIG. 5 is similar to the cross-sectional structure of the pixel TFT 24.

The inspection drive wiring line 34 is generally L-shaped in plan view, and has a portion extending in the X-axis direction and a portion extending in the Y-axis direction, as illustrated in FIG. 4. The portion of the inspection drive wiring line 34 extending in the X-axis direction crosses all lead portions of the source wiring lines 27 and is connected to all second gate electrodes 33A of the inspection TFTs 33. The portion of the inspection drive wiring line 34 extending in the X-axis direction is a part of the first metal film. With this structure, the portion of the inspection drive wiring line 34 extending in the X-axis direction is directly connected the second gate electrodes 33A. The portion of the inspection drive wiring line 34 extending in the Y-axis direction overlaps an end of the portion extending in the X-axis direction at one end, and is connected to an inspection drive terminal portion 36 at the other end. In the gate insulating film 38, a first contact hole CH1 is open at a position where the gate insulating film 38 overlaps both of the portion of the inspection drive wiring line 34 extending in the X-axis direction and the portion of the inspection drive wiring line 34 extending in the Y-axis direction to connect these portions.

The inspection signal wiring line 35 is generally L-shaped in plan view, and has a portion extending in the X-axis direction and a portion extending in the Y-axis direction, as illustrated in FIG. 4. Six inspection signal wiring lines 35 are arranged in parallel at predetermined intervals. The portion of the inspection signal wiring line 35 extending in the X-axis direction crosses all lead portions of the source wiring lines 27 and is connected to the second source electrodes 33B of predetermined inspection TFTs 33. In this embodiment, the number of inspection signal wiring lines 35 is six, and to one inspection signal wiring line 35, ⅙ of all inspection TFTs 33 are connected. The portion of the inspection signal wiring line 35 extending in the X-axis direction is a part of the first metal film. With this structure, the portion of the inspection signal wiring line 35 extending in the X-axis direction is connected to the second source electrodes 33B via a second contact hole CH2 that is open in the gate insulating film 38. The portion of the inspection signal wiring line 35 extending in the Y-axis direction overlaps an end of the portion extending in the X-axis direction at one end, and is connected to an inspection signal terminal portion 37 at the other end. In the gate insulating film 38, a third contact hole CH3 is open at a position where the gate insulating film 38 overlaps both of the portion of the inspection signal wiring line 35 extending in the X-axis direction and the portion of the inspection signal wiring line 35 extending in the Y-axis direction to connect these portions. Of the six inspection signal wiring lines 35, the portion extending in the Y-axis direction of the inspection signal wiring line 35 that is furthest from the driver 12 is spaced apart from the common wiring line 31 in the X-axis direction. The space between the common wiring line 31 and the inspection signal wiring line 35 is approximately equal to the space between adjacent two inspection signal wiring lines 35.

The inspection drive terminal portion 36, in plan view, has a rectangular shape that is slightly wider than the inspection drive wiring line 34 to which the inspection drive terminal portion 36 is connected, as illustrated in FIG. 4. The inspection signal terminal portion 37, in plan view, has a rectangular shape that is slightly wider than the inspection signal wiring line 35 to which the inspection signal terminal portion 37 is connected. Six inspection signal terminal portions 37, which are the same number as the inspection signal wiring lines 35, are spaced apart in the X-axis direction. Of the six inspection signal terminal portions 37, the inspection signal terminal portion 37 that is located at one end (left end in FIG. 4) is spaced apart from the common terminal portion 32 in the X-axis direction. The space between the common terminal portion 32 and the inspection signal terminal portion 37 is approximately equal to the space between adjacent two inspection signal terminal portions 37. The inspection drive terminal portion 36 is spaced apart in the Y-axis direction from the common terminal portion 32 and the inspection signal terminal portion 37. The common terminal portion 32, the inspection drive terminal portion 36, and the inspection signal terminal portions 37 are formed using the first metal film or the second metal film, and the uppermost layers are covered with a part of a transparent electrode film that forms the pixel electrodes 25. The inspection drive terminal portion 36 and the inspection signal terminal portions 37 may be disposed, in the exposed portion 21A of the array substrate 21, at portions where the flexible substrate 13 is mounted or at portions where the inspection drive terminal portion 36 and the inspection signal terminal portions 37 do not overlap the flexible substrate 13. In either case, during the manufacturing process of the liquid crystal panel 11 (for example, at the stage before the flexible substrate 13 is attached), inspection pads provided in an external inspection device are to be connected to the inspection drive terminal portion 36 and the inspection signal terminal portions 37 to supply drive signals and inspection signals from the inspection device. In addition, an inspection pad is to be connected to the common terminal portion 32 such that a common potential signal is to be supplied from the inspection device.

When a drive signal is input from the inspection pad to the inspection drive terminal portion 36, the drive signal is supplied via the inspection drive wiring line 34 to the second gate electrodes 33A. By the drive signal, the inspection TFTs 33 are driven and channel regions are generated in the second semiconductor portions 33D. This drive signal includes a potential higher than a threshold voltage of the inspection TFTs 33. An inspection signal input from the inspection pad to the inspection signal wiring lines 35 is supplied to the second source electrodes 33B via the inspection signal wiring lines 35 and thus the inspection signal is supplied to the second drain electrodes 33C via the channel regions generated in the second semiconductor portions 33D. As a result, the inspection signal is supplied to the source wiring lines 27. At this time, if a scanning signal has been supplied to the gate wiring lines 26, by driving the pixel TFTs 24, the pixel electrodes 25 are charged to a potential according to the inspection signal transmitted via the source wiring lines 27.

In the following description, when distinguishing between the six inspection signal wiring lines 35, the inspection signal wiring line 35 that is disposed at the leftmost end in FIG. 4 (furthest from the driver 12) is referred to as “first inspection signal wiring line (second wiring line)” and a subscript “α” is added to the reference numeral, the inspection signal wiring line 35 that is disposed at the second position from the leftmost end in FIG. 4 is referred to as “second inspection signal wiring line (fourth wiring line)” and a subscript “β” is added to the reference numeral, the inspection signal wiring line 35 that is disposed at the third position from the leftmost end in FIG. 4 is referred to as “third inspection signal wiring line (third wiring line)” and a subscript “γ” is added to the reference numeral, the inspection signal wiring line 35 that is disposed at the fourth position from the leftmost end in FIG. 4 is referred to as “fourth inspection signal wiring line” and a subscript “α” is added to the reference numeral, the inspection signal wiring line 35 that is disposed at the fifth position from the leftmost end in FIG. 4 is referred to as “fifth inspection signal wiring line” and a subscript “ε” is added to the reference numeral, the inspection signal wiring line 35 that is disposed at the rightmost end in FIG. 4 is referred to as “sixth inspection signal wiring line” and a subscript “ζ” is added to the reference numeral, and when the six inspection signal wiring lines 35 are collectively referred to without distinction, no subscript is added to the reference numerals.

When distinguishing between the six inspection signal terminal portions 37, the inspection signal terminal portion 37 that is connected to the first inspection signal wiring line 35α is referred to as “first inspection signal terminal portion (first inspection terminal portion)” and a subscript “α” is added to the reference numeral, the inspection signal terminal portion 37 that is connected to the second inspection signal wiring line 35β is referred to as “second inspection signal terminal portion (second inspection terminal portion)” and a subscript “β” is added to the reference numeral, the inspection signal terminal portion 37 that is connected to the third inspection signal wiring line 35γ is referred to as “third inspection signal terminal portion” and a subscript “γ” is added to the reference numeral, the inspection signal terminal portion 37 that is connected to the fourth inspection signal wiring line 35δ is referred to as “fourth inspection signal terminal portion” and a subscript “α” is added to the reference numeral, the inspection signal terminal portion 37 that is connected to the fifth inspection signal wiring line 35ε is referred to as “fifth inspection signal terminal portion” and a subscript “ε” is added to the reference numeral, the inspection signal terminal portion 37 that is connected to the sixth inspection signal wiring line 35ζ is referred to as “sixth inspection signal terminal portion” and a subscript “ζ” is added to the reference numeral, and when the six inspection signal terminal portions 37 are collectively referred to without distinction, no subscript is added to the reference numerals. In inspection, to each of the first inspection signal terminal portion 37α, the third inspection signal terminal portion 37γ, and the fifth inspection signal terminal portion 37ε, a first inspection signal is input from an external inspection device. On the other hand, to each of the second inspection signal terminal portion 37β, the fourth inspection signal terminal portion 37δ, and the sixth inspection signal terminal portion 37ζ, a second inspection signal that has the opposite polarity to the first inspection signal is input from the external inspection device.

When distinguishing between the plurality of inspection TFTs 33, the inspection TFT 33 that is connected to the first inspection signal wiring line 35α is referred to as “first inspection TFT (first switching element)” and a subscript “α” is added to the reference numeral, the inspection TFT 33 that is connected to the second inspection signal wiring line 35R is referred to as “second inspection TFT (third switching element)” and a subscript “β” is added to the reference numeral, the inspection TFT 33 that is connected to the third inspection signal wiring line 35γ is referred to as “third inspection TFT” and a subscript “γ” is added to the reference numeral, the inspection TFT 33 that is connected to the fourth inspection signal wiring line 35δ is referred to as “fourth inspection TFT” and a subscript “δ” is added to the reference numeral, the inspection TFT 33 that is connected to the fifth inspection signal wiring line 35ε is referred to as “fifth inspection TFT” and a subscript “ε” is added to the reference numeral, the inspection TFT 33 that is connected to the sixth inspection signal wiring line 35ζ is referred to as “sixth inspection TFT” and a subscript “ζ” is added to the reference numeral, and when the plurality of inspection TFTs 33 are collectively referred to without distinction, no subscript is added to the reference numerals.

When distinguishing between the plurality of source wiring lines 27, the source wiring line 27 that is connected to the first inspection TFT 33α is referred to as “first source wiring line (third wiring line)” and a subscript “α” is added to the reference numeral, the source wiring line 27 that is connected to the second inspection TFT 33β is referred to as “second source wiring line (fifth wiring line)” and a subscript “β” is added to the reference numeral, the source wiring line 27 that is connected to the third inspection TFT 33γ is referred to as “third source wiring line” and a subscript “γ” is added to the reference numeral, the source wiring line 27 that is connected to the fourth inspection TFT 33δ is referred to as “fourth source wiring line” and a subscript “δ” is added to the reference numeral, the source wiring line 27 that is connected to the fifth inspection TFT 33E is referred to as “fifth source wiring line” and a subscript “ε” is added to the reference numeral, the source wiring line 27 that is connected to the sixth inspection TFT 33ζ is referred to as “sixth source wiring line” and a subscript “ζ” is added to the reference numeral, and when the plurality of source wiring lines 27 are collectively referred to without distinction, no subscript is added to the reference numerals.

When distinguishing between the plurality of pixel TFTs 24, the pixel TFT 24 that is connected to the first source wiring line 27α is referred to as “first pixel TFT (second switching element)” and a subscript “α” is added to the reference numeral, the pixel TFT 24 that is connected to the second source wiring line 27β is referred to as “second pixel TFT (fourth switching element)” and a subscript “β” is added to the reference numeral, the pixel TFT 24 that is connected to the third source wiring line 27γ is referred to as “third pixel TFT” and a subscript “γ” is added to the reference numeral, the pixel TFT 24 that is connected to the fourth source wiring line 276 is referred to as “fourth pixel TFT” and a subscript “δ” is added to the reference numeral, the pixel TFT 24 that is connected to the fifth source wiring line 27E is referred to as “fifth pixel TFT” and a subscript “ε” is added to the reference numeral, the pixel TFT 24 that is connected to the sixth source wiring line 27ζ is referred to as “sixth pixel TFT” and a subscript “ζ” is added to the reference numeral, and when the plurality of pixel TFTs 24 are collectively referred to without distinction, no subscript is added to the reference numerals.

When distinguishing between the plurality of pixel electrodes 25, the pixel electrode 25 that is connected to the first pixel TFT 24α is referred to as “first pixel electrode” and a subscript “α” is added to the reference numeral, the pixel electrode 25 that is connected to the second pixel TFT 24β is referred to as “second pixel electrode” and a subscript “β” is added to the reference numeral, the pixel electrode 25 that is connected to the third pixel TFT 24γ is referred to as “third pixel electrode” and a subscript “γ” is added to the reference numeral, the pixel electrode 25 that is connected to the fourth pixel TFT 246 is referred to as “fourth pixel electrode” and a subscript “δ” is added to the reference numeral, the pixel electrode 25 that is connected to the fifth pixel TFT 24E is referred to as “fifth pixel electrode” and a subscript “ε” is added to the reference numeral, the pixel electrode 25 that is connected to the sixth pixel TFT 24ζ is referred to as “sixth pixel electrode” and a subscript “ζ” is added to the reference numeral, and when the plurality of pixel electrodes 25 are collectively referred to without distinction, no subscript is added to the reference numerals.

Here, the connections between the inspection signal wiring lines 35 and the inspection TFTs 33 will be described in detail. Note that “n” in the following is a natural number. To the first inspection signal wiring line 35α, a plurality of first inspection TFTs 33α disposed at the (6n−5)th positions from the left end in FIG. 4 are connected. To the second inspection signal wiring line 35β, a plurality of second inspection TFTs 33β disposed at the (6n−4)th positions from the left end in FIG. 4 are connected. To the third inspection signal wiring line 35γ, a plurality of third inspection TFTs 33γ disposed at the (6n−3)th positions from the left end in FIG. 4 are connected. To the fourth inspection signal wiring line 356, a plurality of fourth inspection TFTs 33δ disposed at the (6n−2)th positions from the left end in FIG. 4 are connected. To the fifth inspection signal wiring line 35ε, a plurality of fifth inspection TFTs 33ε disposed at the (6n−1)th positions from the left end in FIG. 4 are connected. To the sixth inspection signal wiring line 35ζ, a plurality of sixth inspection TFTs 33ζ disposed at the 6nth positions from the left end in FIG. 4 are connected. The number of the first inspection TFTs 33α, the number of the second inspection TFTs 33β, the number of the third inspection TFTs 33γ, the number of the fourth inspection TFTs 336, the number of the fifth inspection TFTs 33ε, and the number of the sixth inspection TFTs 33ζ are the same, and the number is equal to ⅙ of the total number of the inspection TFTs 33.

Next, the connections between the inspection TFTs 33 and the source wiring lines 27 will be described in detail. Note that “n” in the following is a natural number. To the plurality of first inspection TFTs 33α, a plurality of first source wiring lines 27α disposed at the (6n−5)th positions from the left end in FIG. 4 are connected. To the plurality of second inspection TFTs 33β, a plurality of second source wiring lines 27β disposed at the (6n−4)th positions from the left end in FIG. 4 are connected. To the plurality of third inspection TFTs 33γ, a plurality of third source wiring lines 27γ disposed at the (6n−3)th positions from the left end in FIG. 4 are connected. To the plurality of fourth inspection TFTs 33δ, a plurality of fourth source wiring lines 27δ disposed at the (6n−2)th positions from the left end in FIG. 4 are connected. To the plurality of fifth inspection TFTs 33ε, a plurality of fifth source wiring lines 27ε disposed at the (6n−1)th positions from the left end in FIG. 4 are connected. To the plurality of sixth inspection TFTs 33ζ, a plurality of sixth source wiring lines 27ζ disposed at the 6nth positions from the left end in FIG. 4 are connected. The number of the first source wiring lines 27α, the number of the second source wiring lines 27P, the number of the third source wiring lines 27γ, the number of the fourth source wiring lines 276, the number of the fifth source wiring lines 27ε, and the number of the sixth source wiring lines 27ζ are the same, and the number is equal to ⅙ of the total number of the source wiring lines 27.

Next, the connections between the source wiring lines 27 and the pixel TFTs 24 will be described in detail. Note that “n” in the following is a natural number. To the plurality of first source wiring lines 27α, a plurality of first pixel TFTs 24α disposed at the (6n−5)th positions from the left end in FIG. 4 are connected. To the plurality of second source wiring lines 27P, a plurality of second pixel TFTs 24β disposed at the (6n−4)th positions from the left end in FIG. 4 are connected. To the plurality of third source wiring lines 27γ, a plurality of third pixel TFTs 24γ disposed at the (6n−3)th positions from the left end in FIG. 4 are connected. To the plurality of fourth source wiring lines 27δ, a plurality of fourth pixel TFTs 24δ disposed at the (6n−2)th positions from the left end in FIG. 4 are connected. To the plurality of fifth source wiring lines 27ε, a plurality of fifth pixel TFTs 24ε disposed at the (6n−1)th positions from the left end in FIG. 4 are connected. To the plurality of sixth source wiring lines 27ζ, a plurality of sixth pixel TFTs 24ζ disposed at the 6nth positions from the left end in FIG. 4 are connected. The number of the first pixel TFTs 24α, the number of the second pixel TFTs 24β, the number of the third pixel TFTs 24γ, the number of the fourth pixel TFTs 24δ, the number of the fifth pixel TFTs 24ε, and the number of the sixth pixel TFTs 24ζ are the same, and the number is equal to ⅙ of the total number of the pixel TFTs 24.

Next, the connections between the pixel TFTs 24 and the pixel electrodes 25 will be described in detail. Note that “n” in the following is a natural number. To the plurality of first pixel TFTs 24α, a plurality of first pixel electrodes 25α disposed at the (6n−5)th positions from the left end in FIG. 4 are connected. To the plurality of second pixel TFTs 24β, a plurality of second pixel electrodes 25P disposed at the (6n−4)th positions from the left end in FIG. 4 are connected. To the plurality of third pixel TFTs 24γ, a plurality of third pixel electrodes 25γ disposed at the (6n−3)th positions from the left end in FIG. 4 are connected. To the plurality of fourth pixel TFTs 24δ, a plurality of fourth pixel electrodes 25δ disposed at the (6n−2)th positions from the left end in FIG. 4 are connected. To the plurality of fifth pixel TFTs 24ε, a plurality of fifth pixel electrodes 25ε disposed at the (6n−1)th positions from the left end in FIG. 4 are connected. To the plurality of sixth pixel TFTs 24ζ, a plurality of sixth pixel electrodes 25ζ disposed at the 6nth positions from the left end in FIG. 4 are connected. The number of the first pixel electrodes 25α, the number of the second pixel electrodes 25β, the number of the third pixel electrodes 25γ, the number of the fourth pixel electrodes 25δ, the number of the fifth pixel electrodes 25ε, and the number of the sixth pixel electrodes 25ζ are the same, and the number is equal to ⅙ of the total number of the pixel electrodes 25. In this embodiment, each of the first pixel electrodes 25α and the fourth pixel electrodes 25δ serves as a red pixel, each of the second pixel electrodes 25β and the fifth pixel electrodes 25ε serves as a green pixel, and each of the third pixel electrodes 25γ and the sixth pixel electrodes 25ζ serves as a blue pixel

In the non-display area NAA of the array substrate 21 according to the embodiment, as illustrated in FIG. 6 and FIG. 7, a connection portion 39 that is connected to the common wiring line 31 and the plurality of inspection signal wiring lines 35 is provided. The connection portion 39 comprises a material whose electrical resistance changes with temperature. More specifically, the connection portion 39 is a part of the semiconductor film, that is, comprises a semiconductor material. Such a semiconductor material has the property of reversibly becoming conductive when heated. The connection portion 39 comprising a semiconductor material functions as an insulator in an environment below a certain temperature but functions as a conductor in an environment above a certain temperature. Accordingly, by providing an environment above a certain temperature, the common wiring line 31 and the plurality of inspection signal wiring lines 35 can be electrically connected via the connection portion 39 that has become a conductor. With this structure, the plurality of inspection signal wiring lines 35 can be set to the same common potential as the common wiring line 31, and accordingly, even if charge accumulation, i.e., charge build-up occurs in the plurality of inspection signal wiring lines 35 or the plurality of pixel electrodes 25 or other elements indirectly connected to the plurality of inspection signal wiring lines 35, such charge can be removed. By removing charge, charge build-up in the plurality of pixel electrodes 25 and other elements can be suppressed, reducing the occurrence of display defects such as a flicker in the image displayed in the display area AA of the liquid crystal panel 11, thereby achieving good display quality.

In the operating environment of the liquid crystal panel 11 (array substrate 21) according to the embodiment, the lower limit of the expected ambient temperature is set to minus several tens of degrees Celsius, and the upper limit of the expected ambient temperature is set to plus several tens of degrees Celsius. In the operating environment of the array substrate 21, actual ambient temperatures are almost always within the expected ambient temperature range defined by the upper limit and the lower limit. In contrast, the connection portion 39 is configured to become non-conductive at the upper limit of the expected ambient temperature and become conductive at a first temperature that is higher than the upper limit of the expected ambient temperature. For example, the first temperature is set to approximately +130° C., and the difference between the first temperature and the upper limit of the expected ambient temperature is several tens of degrees Celsius. This structure increases the reliability of preventing the connection portion 39 from unintentionally becoming conductive in actual use.

The connection portion 39, which is a part of the semiconductor film, is connected in a direct contact manner to the common wiring line 31 and the plurality of inspection signal wiring lines 35, which are parts of the second metal film disposed on the upper layer side to the semiconductor film, as illustrated in FIG. 7. The connection portion 39 is spaced apart in the Y-axis direction from the common terminal portion 32 and the inspection signal terminal portions 37, as illustrated in FIG. 6. The connection portion 39 has a band-like shape extending in the X-axis direction. The connection portion 39 is disposed to cross all of a portion of the common wiring line 31 extending in the Y-axis direction and portions of the plurality of inspection signal wiring lines 35α extending in the Y-axis direction. With this structure, the common wiring line 31 and the plurality of inspection signal wiring lines 35 can be connected to the connection portion 39 without changing the design of the common wiring line 31 and the plurality of inspection signal wiring lines 35.

In this embodiment, as illustrated in FIG. 6 and FIG. 7, the connection portion 39 is connected to all inspection signal wiring lines 35α to 35ζ from the first inspection signal wiring line 35α to the sixth inspection signal wiring line 35ζ, in addition to the common wiring line 31. When charge removal is performed, the ambient temperature of the array substrate 21 is set to a first temperature or higher such that the connection portion 39 becomes conductive. Here, since both of the first semiconductor portions 24D of the pixel TFTs 24 and the second semiconductor portions 33D of the inspection TFTs 33 are parts of the semiconductor film similarly to the connection portion 39, when the ambient temperature of the array substrate 21 becomes to the first temperature or higher, the first semiconductor portions 24D and the second semiconductor portions 33D also become conductive. Accordingly, to the inspection signal wiring lines 35α to 35ζ, the inspection TFTs 33α to 33ζ, the source wiring lines 27α to 27ζ, and the pixel electrodes 25α to 25ζ via the pixel TFTs 24α to 24ζ are electrically connected respectively, and all of the inspection signal wiring lines 35α to 35ζ are electrically connected to the common wiring line 31 via the connection portion 39. With this structure, a common potential of the common wiring line 31 is supplied to all pixel electrodes 25, thereby suppressing the occurrence of a potential difference between the pixel electrodes 25.

In the subsequent inspection, first inspection signals and second inspection signals with reversed polarities are input to each inspection signal terminal portion 37 from the external inspection device. Then, the first inspection signal is input from the first inspection signal terminal portion 37α, the third inspection signal terminal portion 37γ, and the fifth inspection signal terminal portion 37ϵ, via the first inspection signal wiring line 35α, the third inspection signal wiring line 35γ, and the fifth inspection signal wiring line 35ε, the first inspection TFTs 33α, the third inspection TFTs 33γ, and the fifth inspection TFTs 33ε, the first source wiring lines 27α, the third source wiring lines 27γ, and the fifth source wiring lines 27ε, and the first pixel TFTs 24α, the third pixel TFTs 24γ, and the fifth pixel TFTs 24ε, to the first pixel electrodes 25α, the third pixel electrodes 25γ, and the fifth pixel electrodes 25ε. The second inspection signal is input from the second inspection signal terminal portion 37β, the fourth inspection signal terminal portion 37δ, and the sixth inspection signal terminal portion 37ζ, via the second inspection signal wiring line 35β, the fourth inspection signal wiring line 35δ, and the sixth inspection signal wiring line 35ζ, the second inspection TFTs 33β, the fourth inspection TFTs 33δ, and the sixth inspection TFTs 33ζ, the second source wiring lines 27β, the fourth source wiring lines 27δ, and the sixth source wiring lines 27ζ, and the second pixel TFTs 24β, the fourth pixel TFTs 24δ, and the sixth pixel TFTs 24ζ, to the second pixel electrodes 25β, the fourth pixel electrodes 25δ, and the sixth pixel electrodes 25ζ. Accordingly, the first pixel TFTs 24α, the third pixel TFTs 24γ, and the fifth pixel TFTs 24ε, and the second pixel electrodes 25β, the fourth pixel electrodes 25δ, and the sixth pixel electrodes 25ζ are charged to opposite potentials. Therefore, if a charge build-up occurs in any of the pixel electrodes 25 and a potential difference occurs between the potential and the common potential, a display defect called flicker may become visible. In this embodiment, however, the common wiring line 31 and all inspection signal wiring lines 35 are electrically connected via the connection portion 39 that has become conductive prior to the inspection to set the potentials of all pixel electrodes 25 to the common potential, and thereby suppressing the occurrence of flicker during inspection.

The structure according to the embodiment has been described above, and a method of manufacturing the array substrate 21 will now be described. The array substrate 21 is manufactured through a photolithography process S1, an annealing process (process of bring the substrate into conduction, resistance-lowering process) S2, and an inspection process S3, as illustrated in FIG. 8.

It should be noted that the term “patterning” refers to film processing based on general photolithography methods. Specifically, a photoresist film is deposited on a target film, exposed through a photomask having a predetermined opening pattern by using an exposure device, developed, and then etched through the developed photoresist film to process the target film, that is, perform patterning.

In the photolithography process S1, a first metal film is first deposited on the glass substrate 21GS, and then the first metal film is patterned using a known photolithography method (see FIG. 5). Through this processing, the first gate electrodes 24A of the pixel TFTs 24, the second gate electrodes 33A of the inspection TFTs 33, the gate wiring lines 26, and other elements are provided, and also parts of the inspection drive wiring line 34 and the inspection signal wiring lines 35 (parts extending in the X-axis direction) are provided (see FIG. 4). Then, the gate insulating film 38 is deposited on the upper layer side to the first metal film, and then the gate insulating film 38 is patterned using a known photolithography method (see FIG. 5). Through this processing, each of the contact holes CH1, CH2, and CH3 is provided (see FIG. 4).

The semiconductor film is then deposited on the upper layer side to the gate insulating film 38, and then the semiconductor film is patterned using a known photolithography method. Through this processing, the first semiconductor portions 24D of the pixel TFTs 24, the second semiconductor portions 33D of the inspection TFTs 33, the connection portion 39, and other elements are formed. Then, the second metal film is deposited on the upper layer side to the semiconductor film, and then the second metal film is patterned using a known photolithography method. Through this processing, the first source electrodes 24B of the pixel TFTs 24, the first drain electrodes 24C, the second source electrodes 33B and the second drain electrodes 33C of the inspection TFTs 33, the source wiring lines 27, the common wiring line 31, and other elements are provided, and also parts of the inspection drive wiring line 34 and the inspection signal wiring lines 35 (parts extending in the Y-axis direction) are provided (see FIG. 4). In this processing, the common wiring line 31 and the plurality of inspection signal wiring lines 35 are connected to the connection portion 39. In addition, of the inspection drive wiring line 34 and the inspection signal wiring lines 35, the parts of the first metal film and the parts of the second metal film are connected via the contact holes CH1 and CH3 respectively. In addition, the parts of the first metal film of the inspection signal wiring lines 35 and the second source electrodes 33B of the inspection TFTs 33 are connected via the second contact holes CH2 respectively.

The array substrate 21 that has undergone the above-described photolithography process S1 is bonded to the opposite substrate 20 with the liquid crystal layer 22 therebetween, and thereby the liquid crystal panel 11 is manufactured. In the annealing process S2, an annealing process is performed. Specifically, the manufactured liquid crystal panel 11 (including the array substrate 21) is placed in an electric furnace or the like, the internal temperature is set to the first temperature or higher, and the temperature is maintained for a predetermined period of time. The connection portion 39 of the array substrate 21 illustrated in FIG. 6 and FIG. 7 gradually decreases in electrical resistance as the internal temperature of the electric furnace rises, and becomes conductive. As a result, all inspection signal wiring lines 35α to 35ζ are connected to the common wiring line 31 via the conductive connection portion 39.

At this time, the first semiconductor portions 24D of the pixel TFTs 24 and the second semiconductor portions 33D of the inspection TFTs 33, which are parts of the semiconductor film similarly to the connection portion 39, also become conductive. Accordingly, as illustrated in FIG. 4, to the first inspection signal wiring line 35α, the plurality of first source wiring lines 27α are electrically connected via the plurality of first inspection TFTs 33a having the conductive second semiconductor portions 33D, and to the first source wiring lines 27α, the plurality of first pixel electrodes 25α are electrically connected via the plurality of first pixel TFTs 24α having the conductive first semiconductor portions 24D. Similarly, to the second inspection signal wiring line 35β, the plurality of second source wiring lines 27β are electrically connected via the plurality of second inspection TFTs 33β having the conductive second semiconductor portions 33D, and to the second source wiring lines 27β, the plurality of second pixel electrodes 25β are electrically connected via the plurality of second pixel TFTs 24β having the conductive first semiconductor portions 24D. Similarly, to the third inspection signal wiring line 35γ, the plurality of third source wiring lines 27γ are electrically connected via the plurality of third inspection TFTs 33γ having the conductive second semiconductor portions 33D, and to the third source wiring lines 27γ, the plurality of third pixel electrodes 25γ are electrically connected via the plurality of third pixel TFTs 24γ having the conductive first semiconductor portions 24D. Similarly, to the fourth inspection signal wiring line 35δ, the plurality of fourth source wiring lines 27δ are electrically connected via the plurality of fourth inspection TFTs 33δ having the conductive second semiconductor portions 33D, and to the fourth source wiring lines 27δ, the plurality of fourth pixel electrodes 25δ are electrically connected via the plurality of fourth pixel TFTs 246 having the conductive first semiconductor portions 24D. Similarly, to the fifth inspection signal wiring line 35ε, the plurality of fifth source wiring lines 27ε are electrically connected via the plurality of fifth inspection TFTs 33ε having the conductive second semiconductor portions 33D, and to the fifth source wiring lines 27ε, the plurality of fifth pixel electrodes 25ε are electrically connected via the plurality of fifth pixel TFTs 24ε having the conductive first semiconductor portions 24D. Similarly, to the sixth inspection signal wiring line 35ζ, the plurality of sixth source wiring lines 27ζ are electrically connected via the plurality of sixth inspection TFTs 33ζ having the conductive second semiconductor portions 33D, and to the sixth source wiring lines 27ζ, the plurality of sixth pixel electrodes 25ζ are electrically connected via the plurality of sixth pixel TFTs 24ζ having the conductive first semiconductor portions 24D. In this manner, the common potential of the common wiring line 31 is supplied to all pixel electrodes 25α to 25ζ via the inspection signal wiring line 35α to 35ζ and other elements, thereby suppressing the occurrence of potential differences between the pixel electrodes 25α to 25ζ. As a result, the occurrence of charge build-up in the pixel electrodes 25α to 25ζ can be suppressed.

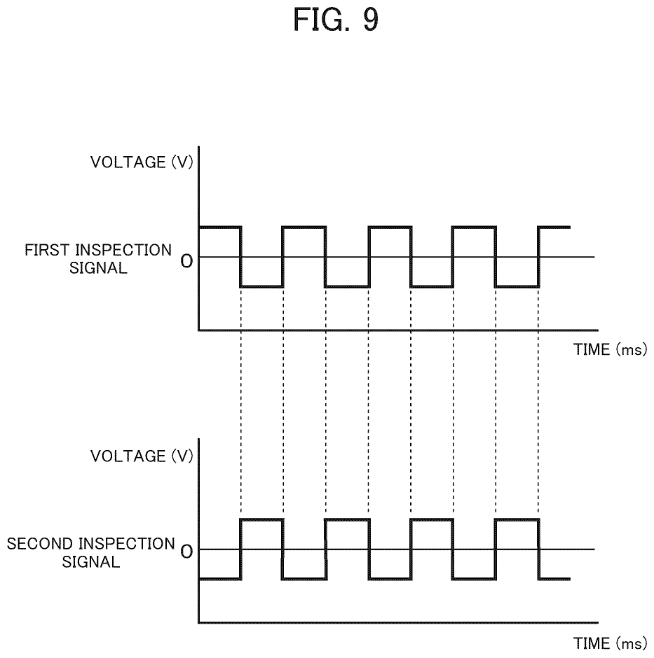

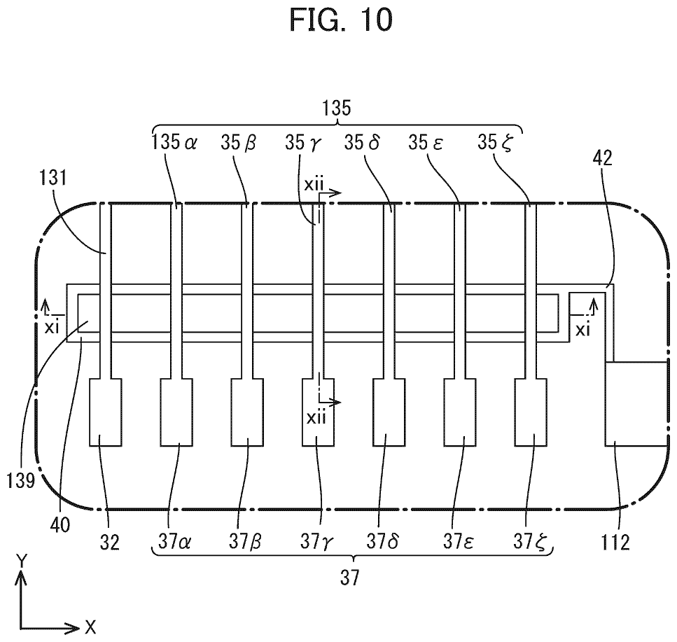

In the inspection process S3, inspection pads provided in an external inspection device are connected to the inspection drive terminal portion 36 and the plurality of inspection signal terminal portions 37 of the liquid crystal panel 11 (including the array substrate 21) that has undergone the annealing process S2 (see FIG. 4). At this time, the inspection pads are also connected to a terminal, which is connected to the gate drive circuit 15, of a terminal group provided in the array substrate 21. To the inspection drive terminal portion 36, a drive signal is supplied from the external inspection device via the inspection pad, and to the plurality of inspection signal terminal portions 37, an inspection signal is supplied from the external inspection device via the inspection pads. For inspection, a backlight device for inspection is disposed on the rear side of the liquid crystal panel 11, and the backlight device for inspection is turned on according to the supply of the drive signal and the inspection signal. The inspection signal includes a first inspection signal and a second inspection signal illustrated in FIG. 9. The graph in the upper part in FIG. 9 shows the waveform of the first inspection signal and the graph in the lower part in FIG. 9 shows the waveform of the second inspection signal. The horizontal axis of the graph shown in FIG. 9 represents time (unit: ms), and the vertical axis represents potential (unit: V). As illustrated in FIG. 9, the first inspection signal and the second inspection signal are both rectangular waves that repeat a positive first potential and a negative second potential at a predetermined cycle, but the polarities of the two signals are reversed. More specifically, during a period in which the first inspection signal is at the positive first potential, the second inspection signal is at the negative second potential, whereas during a period in which the first inspection signal is at the negative second potential, the second inspection signal is at the positive first potential. The absolute values (differences from 0 V) of the positive first potential and the negative second potential are the same.

As illustrated in FIG. 4, when the first inspection signal is supplied from the inspection pads to the first inspection signal terminal portion 37α, the third inspection signal terminal portion 37γ, and the fifth inspection signal terminal portion 37ε, the first inspection signal is supplied from the first inspection signal wiring line 35α, the third inspection signal wiring line 35γ, and the fifth inspection signal wiring line 35ε, via the first inspection TFTs 33α, the third inspection TFTs 33γ, and the fifth inspection TFTs 33ε, which are in the drive state, to the first source wiring lines 27α, the third source wiring lines 27γ, and the fifth source wiring lines 27ε. When the second inspection signal is supplied from the inspection pads to the second inspection signal terminal portion 37β, the fourth inspection signal terminal portion 37δ, and the sixth inspection signal terminal portion 37ζ, the second inspection signal is supplied from the second inspection signal wiring line 35β, the fourth inspection signal wiring line 35δ, and the sixth inspection signal wiring line 35ζ, via the second inspection TFTs 33β, the fourth inspection TFTs 33δ, and the sixth inspection TFTs 33ζ, which are in the drive state, to the second source wiring lines 27β, the fourth source wiring lines 27δ, and the sixth source wiring lines 27ζ. Here, in the inspection, a scanning signal is supplied sequentially from the gate drive circuit 15 to the plurality of gate wiring lines 26, for example, from the top row to the bottom row, to drive all of the plurality of pixel TFTs 24 connected to the gate wiring lines 26. Accordingly, the first inspection signal is supplied via the first pixel TFTs 24α, the third pixel TFTs 24γ, and the fifth pixel TFTs 24ε, which are driven, to the first pixel electrodes 25α, the third pixel electrode 25γ, and the fifth pixel electrode 25ε. The second inspection signal is supplied via the second pixel TFTs 24β, the fourth pixel TFTs 24δ, and the six pixel TFTs 24ζ, which are driven, to the second pixel electrodes 25P, the fourth pixel electrode 25δ, and the sixth pixel electrode 25ζ. As a result, an image for inspection is displayed in the display area AA of the liquid crystal panel 11 using light from the backlight device for inspection. Here, if a break occurs in any of the source wiring lines 27α to 27ζ or a malfunction occurs in any of the pixel TFTs 24α to 24ζ, the pixel electrodes 25α to 25ζ connected to the source wiring lines 27α to 27ζ and the pixel TFTs 24α to 24ζ are no longer charged. In such a case, the inspection image displayed on the liquid crystal panel 11 exhibits dark spots or lines, enabling the source wiring lines 27α to 27ζ or the pixel TFTs 24α to 24ζ at which the defect has occurred to be identified based on the positions and ranges of the dark spots or lines. In this manner, the inspection of the source wiring lines 27α to 27ζ, the pixel TFTs 24α to 24ζ, and other elements can be performed.

In the inspection process S3, the first pixel electrodes 25α and the fourth pixel electrodes 25δ both form red pixels, but are charged to opposite potentials. Similarly, the second pixel electrodes 25β and the fifth pixel electrodes 25ε both form green pixels, but are charged to opposite potentials. The third pixel electrodes 25γ and the sixth pixel electrodes 25ζ both form blue pixels, but are charged to opposite polarities. In addition, the plurality of pixel electrodes 25 disposed in the X-axis direction have polarities opposite each other in the X-axis direction between adjacent pixel electrodes 25. Accordingly, if a charge build-up occurs in any of the pixel electrodes 25 and a potential difference occurs between the potential and the common potential, a display defect called flicker may become visible. In this embodiment, however, the common wiring line 31 and all inspection signal wiring lines 35 are electrically connected via the connection portion 39 that has been made conductive in the annealing process S2 performed prior to the inspection process S3, and thereby the potentials of all pixel electrodes 25 are set to the common potential. Accordingly, when the inspection is performed in the inspection process S3, flickering is less likely to be observed.

As described above, the array substrate (wiring substrate) 21 according to the embodiment includes the common wiring line (first wiring line) 31 that provides the common potential, the first inspection signal wiring line (second wiring line) 35α disposed to be spaced apart from the common wiring line 31, and the connection portion 39 connected to the common wiring line 31 and the first inspection signal wiring line 35α, in which the connection portion 39 comprises a material whose electrical resistance changes with temperature.

The connection portion 39 comprising the material whose electrical resistance changes with time functions as an insulator in an environment below a certain temperature but functions as a conductor in an environment above a certain temperature. Accordingly, by providing an environment above a certain temperature, the common wiring line 31 and the first inspection signal wiring line 35α can be electrically connected via the connection portion 39 that has become a conductor. In such a manner, the first inspection signal wiring line 35α can be set to the same common potential as the common wiring line 31, and accordingly, even if charge accumulation, i.e., charge build-up, occurs in the first pixel electrode 25α or other elements connected to the first inspection signal wiring line 35α and the first inspection signal wiring line 35α, such charge can be removed.

In addition, the connection portion 39 comprises a semiconductor material. Such a semiconductor material has the property of reversibly becoming conductive when heated. Accordingly, by providing an environment above a certain temperature, the connection portion 39 comprising a semiconductor material becomes conductive, and the common wiring line 31 and the first inspection signal wiring line 35α can be electrically connected.

In addition, the connection portion 39 is disposed to cross the common wiring line 31 and the first inspection signal wiring line 35α. The common wiring line 31 and the first inspection signal wiring line 35α can be connected to the connection portion 39 without changing the design of the common wiring line 31 and the first inspection signal wiring line 35a.

In addition, the first inspection signal terminal portion (first inspection terminal portion) 37α connected to the first inspection signal wiring line 35α and to which a first inspection signal is input, the plurality of first inspection TFTs 33α connected to the first inspection signal wiring line 35α, the plurality of first source wiring lines 27α connected to the plurality of first inspection TFTs 33α, the plurality of first pixel TFTs (second switching elements) 24α connected to the plurality of first source wiring lines 27α, and the plurality of pixel electrodes 25α connected to the plurality of first pixel TFTs 24α are provided. When a first inspection signal is input to the first inspection signal terminal portion 37α in a state in which the plurality of first inspection TFTs 33α and first pixel TFTs 24α are driven, the first inspection signal is transmitted to the plurality of first source wiring lines 27α via the first inspection signal wiring line 35α and the plurality of first inspection TFTs 33α, and then supplied to the plurality of first pixel electrodes 25α via the plurality of first pixel TFTs 24α. Accordingly, if there are no breaks in the plurality of first source wiring lines 27α, and the plurality of first pixel TFTs 24α are driven normally, the plurality of first pixel electrodes 25α are all charged to the potential corresponding to the first inspection signal. Here, if a break occurs in any of the first source wiring lines 27α or a malfunction occurs in any of the first pixel TFTs 24α, the first source wiring line 27α or the first pixel electrode 25a connected to the first pixel TFT 24α is no longer charged. In this manner, the inspection of the first source wiring lines 27α, the first pixel TFTs 24α, and other elements can be performed. When the connection portion 39 becomes conductive while the plurality of first inspection TFTs 33a and first pixel TFTs 24α are driven, the common wiring line 31 and the first inspection signal wiring line 35α become conductive via the connection portion 39, and the common potential is supplied to the plurality of first pixel electrodes 25α via the plurality of first inspection TFTs 33α, first pixel TFTs 24α, and first source wiring lines 27α. Compared to a case in which the common wiring line 31 and the plurality of first source wiring lines 27α are connected via the connection portion 39, only one first inspection signal wiring line 35α needs to be connected to the common wiring line 31 via the connection portion 39. Accordingly, the formation area of the connection portion 39 can be reduced, and the occurrence of connection failure in the connection portion 39 can be reduced.

In addition, the second inspection signal wiring line (fourth wiring line) 35β, which is disposed to be spaced apart from the common wiring line 31 or the first inspection signal wiring line 35α, the second inspection signal terminal portion (second inspection terminal portion) 37β, which is connected to the second inspection signal wiring line 35β and to which a second inspection signal having the polarity reversed from that of the first inspection signal is input, the plurality of second inspection TFTs (third switching elements) 33β connected to the second inspection signal wiring line 35β, the second source wiring lines (fifth wiring lines) 27β connected to the plurality of second inspection TFTs 33β, the plurality of second pixel TFTs (fourth switching elements) 24β connected to the plurality of second source wiring lines 27β, and the plurality of second pixel electrodes 25P connected to the plurality of second pixel TFTs 24β are provided, and the connection portion 39 is connected to the second inspection signal wiring line 35β. When the second inspection signal is input to the second inspection signal terminal portion 37β in a state in which the plurality of second inspection TFTs 33β and second pixel TFTs 24β are driven, the second inspection signal is transmitted to the plurality of second source wiring lines 27β via the second inspection signal wiring line 35R and the plurality of second inspection TFTs 33β, and then supplied to the plurality of second pixel electrodes 25β via the plurality of second pixel TFTs 24β. Accordingly, if there are no breaks in the plurality of second source wiring lines 27β, and the plurality of second pixel TFTs 24β are driven normally, the plurality of second pixel electrodes 25β are all charged to the potential corresponding to the second inspection signal. At this time, the plurality of second pixel electrodes 25β have the polarity that is opposite to that of the plurality of first pixel electrodes 25α. If a break occurs in any of the second source wiring lines 27β or a malfunction occurs in any of the second pixel TFTs 24β, the second source wiring line 27β or the second pixel electrode 25β connected to the second pixel TFT 24β is no longer charged. In this manner, the inspection of the second source wiring lines 27β, the second pixel TFTs 24β, and other elements can be performed. When the connection portion 39 becomes conductive while the plurality of first inspection TFTs 33α, first pixel TFTs 24α, second inspection TFTs 33β, and second pixel TFTs 24R are driven, the common wiring line 31, the first inspection signal wiring line 35α, and the second inspection signal wiring line 35β become conductive via the connection portion 39, and the common potential is supplied to the plurality of first pixel electrodes 25α via the plurality of first inspection TFTs 33α, first pixel TFTs 24α, and first source wiring lines 27α, and also to the plurality of second pixel electrodes 25β via the second inspection TFTs 33β, the second pixel TFTs 24β, and the second source wiring lines 27β. Accordingly, the occurrence of potential differences between the first pixel electrodes 25α and the second pixel electrodes 25β can be suppressed, thereby suppressing the occurrence of display defects called flicker. In addition, compared to a case in which the common wiring line 31 and the plurality of second source wiring lines 273 are connected via the connection portion 39, only one second inspection signal wiring line 353 needs to be connected to the common wiring line 31 via the connection portion 39. Accordingly, the formation area of the connection portion 39 can be reduced, and the occurrence of connection failure in the connection portion 39 can be reduced.

In addition, the connection portion 39 is configured to become non-conductive at the upper limit of the expected ambient temperature and become conductive at a first temperature that is higher than the upper limit. In the operating environment of the array substrate 21, it is presumed that actual ambient temperatures are almost always below the upper limit of the expected ambient temperature. Accordingly, the increased reliability of preventing the connection portion 39 from unintentionally becoming conductive in actual use can be achieved.

The liquid crystal panel (display device) 11 according to the embodiment includes the above-mentioned array substrate 21 and the opposite substrate 20, which is disposed to face the array substrate 21 with a space therebetween. The liquid crystal panel 11 with such a structure suppresses the occurrence of charge build-up in the first inspection signal wiring line 35α, the first pixel electrodes 25α connected to the first inspection signal wiring line 35α, and other elements, and thereby display defects such as flicker or the like can be suppressed, and good display quality can be achieved.

The method of manufacturing the array substrate 21 according to the embodiment includes providing the common wiring line 31, which provides the common potential, the first inspection signal wiring line 35α, which is disposed to be spaced apart from the common wiring line 31, and the connection portion 39, which is connected to the common wiring line 31 and the first inspection signal wiring line 35α and comprises a material whose electrical resistance changes with temperature, and performing the annealing process to lower the resistance of the connection portion 39. The annealing process enables the connection portion 39 comprising a material whose electrical resistance changes with temperature to become conductive, and thereby the common wiring line 31 and the first inspection signal wiring line 35α can be electrically connected via the connection portion 39. With this processing, the first inspection signal wiring line 35α can be set to the same common potential as the common wiring line 31, and accordingly, even if charge accumulation, i.e., charge build-up, occurs in the first inspection signal wiring line 35α, the first pixel electrode 25α that is an electrode connected to the first inspection signal wiring line 35α, and other elements, such charge can be removed.

### Second Embodiment

A second embodiment will be described with reference to FIG. 10 to FIG. 12. In the second embodiment, a light-shielding portion 40 and a first insulating portion 41 are added. Descriptions of structures, operations, and effects similar to those in the above-described first embodiment will be omitted.

In an array substrate 121 according to the embodiment, as illustrated in FIG. 10, the light-shielding portion 40 is provided. The light-shielding portion 40 comprises a light-shielding material that has light-shielding properties, and is disposed to overlap a connection portion 139 in plan view. The light-shielding portion 40 has a band-like shape extending in the X-axis direction, and is disposed to overlap the entire of the connection portion 139. In other words, the light-shielding portion 40 is disposed to cross a common wiring line 131 and all inspection signal wiring lines 135, similarly to the connection portion 139. The light-shielding portion 40 has dimensions in both the X-axis direction and the Y-axis direction that are larger than those of the connection portion 139, and is disposed in a wider area than the connection portion 139 in plan view.

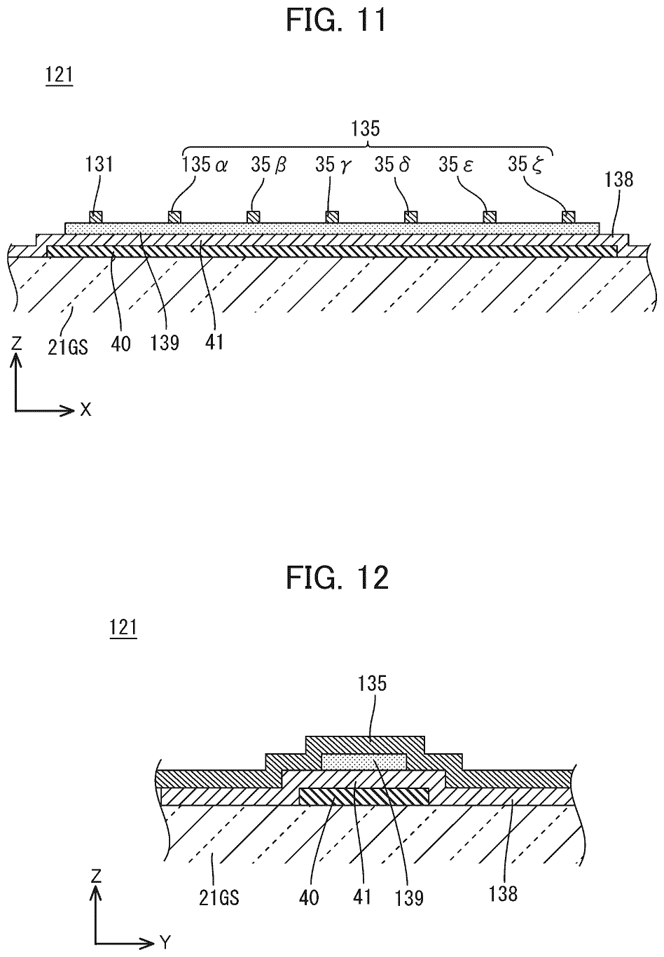

As illustrated in FIG. 11 and FIG. 12, the light-shielding portion 40 is a part of the first metal film similarly to the first gate electrodes 24A, the second gate electrodes 33A, the gate wiring lines 26, and other elements (see FIG. 5). In other words, the light-shielding portion 40 comprises a conductive material that has conductivity. In manufacturing, the formed first metal film is patterned to form the light-shielding portion 40 in addition to the first gate electrodes 24A, the second gate electrodes 33A, the gate wiring lines 26, and other elements. Between the connection portion 139, which is a part of the semiconductor film, and the light-shielding portion 40, which is a part of the first metal film, the first insulating portion 41 is provided. The first insulating portion 41 is a part of a gate insulating film 138 (see FIG. 5), similarly to the second insulating portion 33E. Accordingly, the thickness of the first insulating portion 41 is the same as the thickness of the second insulating portion 33E. In manufacturing, by forming the gate insulating film 138 on the upper layer side to the first metal film, the first insulating portion 41 is provided in addition to the second insulating portion 33E.

In the array substrate 121, a connection wiring line 42 that is connected to the light-shielding portion 40 is provided, as illustrated in FIG. 10. The connection wiring line 42 is connected to the light-shielding portion 40 at one end and to a terminal (not illustrated) provided in a mounting area of a driver 112 at the other end. To the terminal connected to the connection wiring line 42, a predetermined signal is input from the driver 112. The signal input to the terminal is supplied to light-shielding portion 40 via the connection wiring line 42.

The semiconductor material in the connection portion 139 has the property of reversibly becoming conductive when irradiated with light. However, by disposing the light-shielding portion 40 that shields light to overlap the connection portion 139, the light emitted to the connection portion 139 can be blocked by the light-shielding portion 40. For example, even if light is emitted to the liquid crystal panel 11 from a backlight device for inspection in the inspection process S3, the light is blocked by the light-shielding portion 40 and cannot easily reach the connection portion 139. Accordingly, even if light is unintentionally emitted to the connection portion 139, the connection portion 139 is less likely to become conductive, thereby reducing the likelihood of the common wiring line 131 and the inspection signal wiring line 135 being unintentionally short-circuited. For example, the occurrence of malfunctions is suppressed in the inspection process S3, and inspections can be performed without problems. In addition, since the light-shielding portion 40 is disposed in a wider area than the connection portion 139 in plan view, the light emitted obliquely to the connection portion 139 can be efficiently blocked by the light-shielding portion 40. Accordingly, even if light is unintentionally emitted to the connection portion 139, the connection portion 139 is further less likely to become conductive.

In addition, since the first insulating portion 41 is provided between the light-shielding portion 40, which is a conductive material, and the connection portion 139, when a signal of a predetermined potential or higher is input to the light-shielding portion 40, a channel region can be generated in the connection portion 139, which overlaps the light-shielding portion 40 via the first insulating portion 41. Accordingly, by inputting a signal such as the signal described above to the light-shielding portion 40, the common wiring line 131 and the inspection signal wiring line 135 can be electrically connected via the channel region generated in the light-shielding portion 40. As described above, by signal input, which is a method other than heating, the inspection signal wiring line 135 can be set to the same common potential as the common wiring line 131. More specifically, for example, the liquid crystal display device 10 is configured to perform a process called “power-off sequence” when the power is turned off. When the power-off sequence is performed, a signal of a predetermined potential or higher is supplied from the driver 112 to the light-shielding portion 40 via the connection wiring line 42. When the signal is supplied to the light-shielding portion 40, a channel region is formed in in the connection portion 139, which overlaps the light-shielding portion 40 via the first insulating portion 41. As a result, the common wiring line 131 and all inspection signal wiring lines 135 can be electrically connected via the channel region of the connection portion 139. Accordingly, when the power is turned off, the charge accumulated in the inspection signal wiring lines 135, the pixel electrodes 25 connected to the inspection signal wiring lines 135, and other elements can be removed.

As described above, this embodiment includes the light-shielding portion 40, which is disposed to overlap the connection portion 139 and configured to shield light. The semiconductor material has the property of reversibly becoming conductive when irradiated with light. However, by disposing the light-shielding portion 40, which shields light, to overlap the connection portion 139, the light emitted to the connection portion 139 can be blocked by the light-shielding portion 40. Accordingly, even if light is unintentionally emitted to the connection portion 139, the connection portion 139 is less likely to become conductive, thereby reducing the likelihood of the common wiring line 131 and the first inspection signal wiring line 135α being unintentionally short-circuited.

In addition, the first insulating portion 41 is provided between the connection portion 139 and the light-shielding portion 40, and the light-shielding portion 40 comprises a conductive material. When a signal of a predetermined potential or higher is input to the light-shielding portion 40, which comprises a conductive material, a channel region can be generated in the connection portion 139, which overlaps the light-shielding portion 40 via the first insulating portion 41. Accordingly, by inputting a signal such as the signal described above to the light-shielding portion 40, the common wiring line 131 and the first inspection signal wiring line 135α can be electrically connected via the channel region generated in the light-shielding portion 40. In this manner, by signal input, which is a method other than heating, the first inspection signal wiring line 135α can be set to the same common potential as the common wiring line 131.

In addition, the driver (signal supply unit) 112 that supplies a signal to the light-shielding portion 40 in accordance with the execution of the power-off sequence is provided. When the power-off sequence is performed, a signal is supplied from the driver 112 to the light-shielding portion 40, which comprises a conductive material. Then, a channel region is formed in the connection portion 139, which overlaps the light-shielding portion 40 via the first insulating portion 41, and as a result, the common wiring line 131 and the first inspection signal wiring line 135α can be electrically connected via the channel region of the connection portion 139. Accordingly, when the power is turned off, the charge accumulated in the first inspection signal wiring line 135α, the first pixel electrodes 25a connected to the first inspection signal wiring lines 135α, and other elements can be removed.

In addition, the first inspection TFT (first switching element) 33α connected to the first inspection signal wiring line 135α, and the first source wiring line (third wiring line) 27α connected to the first inspection TFT 33α are provided. The first inspection TFT 33α includes the second gate electrode (first electrode) 33A, the second semiconductor portion (semiconductor portion) 33D disposed to overlap the second gate electrode 33A and comprising a semiconductor material, the second insulating portion 33ε disposed between the second gate electrode 33A and the second semiconductor portion 33D, the second source electrode (second electrode) 33B connected to the second semiconductor portion 33D and the first inspection signal wiring line 135α, and the second drain electrode (third electrode) 33C disposed to be spaced apart from the second source electrode 33B and connected to the second semiconductor portion 33D and the first source wiring line 27α. The second gate electrode 33A and the light-shielding portion 40 are parts of the first metal film, the first insulating portion 41 and the second insulating portion 33ε are parts of the gate insulating film (first insulating film) 138 disposed on the upper layer side to the first metal film, the second semiconductor portion 33D and the connection portion 139 are parts of the semiconductor film disposed on the upper layer side to the gate insulating film 138, and the second source electrode 33B and the second drain electrode 33C are parts of the second metal film disposed on the upper layer side to the semiconductor film. When a potential of a threshold value or higher is supplied to the second gate electrode 33A of the first inspection TFT 33α, a channel region is generated in the second semiconductor portion 33D, which overlaps the second gate electrode 33A via the second insulating portion 33E. A signal supplied to the first inspection signal wiring line 135α is supplied from the second source electrode 33B to the second drain electrodes 33C via the channel region in the second semiconductor portion 33D. In this manner, the signal supplied to the first inspection signal wiring line 135α is supplied to the first source wiring lines 27α. In manufacturing, the formed first metal film is patterned to form the second gate electrode 33A and the light-shielding portion 40. The gate insulating film 138 is formed on the upper layer side to the first metal film, and the first insulating portion 41 and the second insulating portion 33E are provided. The semiconductor film is formed on the upper layer side to the gate insulating film 138, and the semiconductor film is patterned to form the second semiconductor portion 33D and the connection portion 139. The second metal film is formed on the upper layer side to the semiconductor film, and the second metal film is patterned to form the second source electrode 33B and the second drain electrode 33C. As described above, since there is no need to form and pattern a dedicated film to provide the connection portion 139 and the light-shielding portion 40, the manufacturing cost can be reduced.

In addition, the light-shielding portion 40 is disposed in a wider area than the connection portion 139 in plan view. The light emitted obliquely to the connection portion 139 can be efficiently blocked by the light-shielding portion 40. Accordingly, even if light is unintentionally emitted to the connection portion 139, the connection portion 139 is further less likely to become conductive.

### Third Embodiment

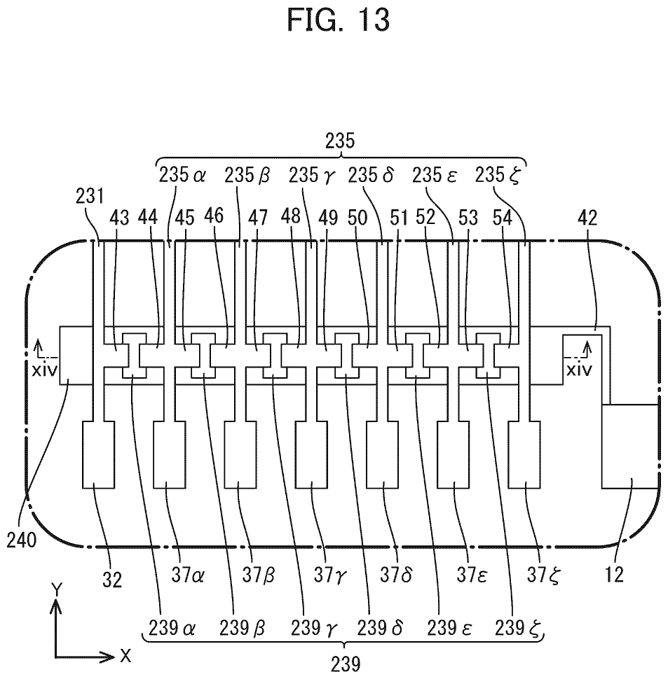

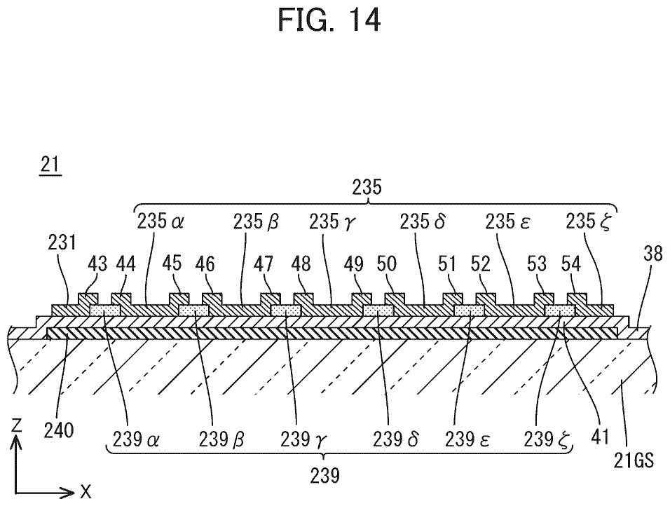

A third embodiment will be described with reference to FIG. 13 or FIG. 14. In the third embodiment, the structures of a common wiring line 231, an inspection signal wiring line 235, and a connection portion 239 are changed from those in the above-described second embodiment. Descriptions of structures, operations, and effects similar to those in the above-described second embodiment will be omitted.

The connection portion 239 according to the embodiment comprises a plurality of connection portions 239 that are disposed to be spaced apart in the X-axis direction, as illustrated in FIG. 13 and FIG. 14. The number of connection potions 239 is set to the number obtained by subtracting one from the sum of the numbers of common wiring line 231 and inspection signal wiring lines 235 (in FIG. 13 and FIG. 14, six). Each connection portion 239 has a smaller area (size when viewed in plan view) than the connection portions 39 and 139 described in the first and second embodiments, and is close to the area of the second semiconductor portion 33D in the inspection TFT 33 (see FIG. 5). The plurality of connection portions 239 include a first connection portion 239α disposed between the common wiring line 231 and the first inspection signal wiring line 235α, and a second connection portion 239P to a sixth connection portion 239ζ disposed between two inspection signal wiring lines 235 adjacent to each other in the X-axis direction. The second connection portion 239P is disposed between the first inspection signal wiring line 235α and the second inspection signal wiring line 235β. The third connection portion 239γ is disposed between the second inspection signal wiring line 235β and the third inspection signal wiring line 235γ. The fourth connection portion 239δ is disposed between the third inspection signal wiring line 235γ and the fourth inspection signal wiring line 235δ. The fifth connection portion 239ε is disposed between the fourth inspection signal wiring line 235δ and the fifth inspection signal wiring line 235E. The sixth connection portion 239ζ is disposed between the fifth inspection signal wiring line 235ε and the sixth inspection signal wiring line 235ζ.

The common wiring line 231 has a first extending portion 43 that extends toward the first inspection signal wiring line 235α side in the X-axis direction and is connected to the first connection portion 239α, as illustrated in FIG. 13 and FIG. 14. The first inspection signal wiring line 235α has a second extending portion 44 that extends toward the common wiring line 231 side in the X-axis direction and is connected to the first connection portion 239α. The first inspection signal wiring line 235α has a third extending portion 45 that extends toward the second inspection signal wiring line 235β side in the X-axis direction and is connected to the second connection portion 239β. The second inspection signal wiring line 235β has a fourth extending portion 46 that extends toward the first inspection signal wiring line 235α side in the X-axis direction and is connected to the second connection portion 239β. The second inspection signal wiring line 235β has a fifth extending portion 47 that extends toward the third inspection signal wiring line 235γ side in the X-axis direction and is connected to the third connection portion 239γ. The third inspection signal wiring line 235γ has a sixth extending portion 48 that extends toward the second inspection signal wiring line 235β side in the X-axis direction and is connected to the third connection portion 239γ.

The third inspection signal wiring line 235γ has a seventh extending portion 49 that extends toward the fourth inspection signal wiring line 235δ side in the X-axis direction and is connected to the fourth connection portion 239δ, as illustrated in FIG. 13 and FIG. 14. The fourth inspection signal wiring line 235δ has an eighth extending portion 50 that extends toward the third inspection signal wiring line 235γ side in the X-axis direction and is connected to the fourth connection portion 239δ. The fourth inspection signal wiring line 235δ has a ninth extending portion 51 that extends toward the fifth inspection signal wiring line 235ε side in the X-axis direction and is connected to the fifth connection portion 239ε. The fifth inspection signal wiring line 235ε has a tenth extending portion 52 that extends toward the fourth inspection signal wiring line 235δ side in the X-axis direction and is connected to the fifth connection portion 239ε. The fifth inspection signal wiring line 235ε has an eleventh extending portion 53 that extends toward the sixth inspection signal wiring line 235ζ side in the X-axis direction and is connected to the sixth connection portion 239ζ. The sixth inspection signal wiring line 235ζ has a twelfth extending portion 54 that extends toward the fifth inspection signal wiring line 235E side in the X-axis direction and is connected to the sixth connection portion 239ζ.

A light-shielding portion 240 has a band-like shape that extends in the X-axis direction to cross the common wiring line 231 and all inspection signal wiring lines 235, and is disposed to overlap all connection portions 239 and extending portions 43 to 54, as illustrated in FIG. 13. The first insulating portion 41 is disposed between the light-shielding portion 240 and each connection portion 239, as illustrated in FIG. 14.

In the annealing process S2, when the annealing process is performed, each connection portion 239 becomes conductive. The conductive first connection portion 239α electrically connects the first extending portion 43 and the second extending portion 44, and thus the common wiring line 231 and the first inspection signal wiring line 235α are electrically connected. The conductive second connection portion 239P electrically connects the third extending portion 45 and the fourth extending portion 46, and thus the first inspection signal wiring line 235α and the second inspection signal wiring line 235β are electrically connected. The conductive third connection portion 239γ electrically connects the fifth extending portion 47 and the sixth extending portion 48, and thus the second inspection signal wiring line 235β and the third inspection signal wiring line 235γ are electrically connected. The conductive fourth connection portion 239δ electrically connects the seventh extending portion 49 and the eighth extending portion 50, and thus the third inspection signal wiring line 235γ and the fourth inspection signal wiring line 235δ are electrically connected. The conductive fifth connection portion 239E electrically connects the ninth extending portion 51 and the tenth extending portion 52, and thus the fourth inspection signal wiring line 235δ and the fifth inspection signal wiring line 235E are electrically connected. The conductive sixth connection portion 239ζ electrically connects the eleventh extending portion 53 and the twelfth extending portion 54, and thus the fifth inspection signal wiring line 235E and the sixth inspection signal wiring line 235ζ are electrically connected. In this manner, by making each connection portion 239 conductive, the common wiring line 231 and all inspection signal wiring lines 235α to 235ζ are electrically connected.

As described above, the first extending portion 43 and the second extending portion 44 are connected to the first connection portion 239α, and the light-shielding portion 240 overlaps the first connection portion 239α via the first insulating portion 41, as illustrated in FIG. 13 and FIG. 14. This structure is similar to the structure of the inspection TFT 33, and the first connection portion 239α corresponds to the second semiconductor portion 33D, the light-shielding portion 240 corresponds to the second gate electrode 33A, the first insulating portion 41 corresponds to the second insulating portion 33E, and the extending portions 43 and 44 correspond to the second source electrode 33B and the second drain electrode 33C respectively (see FIG. 5). Accordingly, in the annealing process S2, when the annealing process is performed, the first connection portion 239α is more likely to become conductive, similarly to the second semiconductor portion 33D and other elements. As a result, the likelihood of the common wiring line 231 and the first inspection signal wiring line 235α being short-circuited by the conductive first connection portion 239α increases.

Similarly, since the structures of the second connection portion 239β, the third extending portion 45, the fourth extending portion 46, and other elements are similar to that of the inspection TFT 33, the second connection portion 239P is highly likely to become conductive by the annealing process. Similarly, since the structures of the third connection portion 239γ, the fifth extending portion 47, the sixth extending portion 48, and other elements are similar to that of the inspection TFT 33, the third connection portion 239γ is highly likely to become conductive by the annealing process. Similarly, since the structures of the fourth connection portion 239δ, the seventh extending portion 49, the eighth extending portion 50, and other elements are similar to that of the inspection TFT 33, the fourth connection portion 239δ is highly likely to become conductive by the annealing process. Similarly, since the structures of the fifth connection portion 239E, the ninth extending portion 51, the tenth extending portion 52, and other elements are similar to that of the inspection TFT 33, the fifth connection portion 239E is highly likely to become conductive by the annealing process. Similarly, since the structures of the sixth connection portion 239ζ, the eleventh extending portion 53, the twelfth extending portion 54, and other elements are similar to that of the inspection TFT 33, the sixth connection portion 239ζ is highly likely to become conductive by the annealing process.

As described above, according to the embodiment, the connection portion 239 is disposed between the common wiring line 231 and the first inspection signal wiring line 235α, and the common wiring line 231 has the first extending portion 43 that extends toward the first inspection signal wiring line 235α side and is connected to the connection portion 239, and the first inspection signal wiring line 235α has the second extending portion 44 that extends toward the common wiring line 231 side and is connected to the connection portion 239. With this structure, the first extending portion 43 and the second extending portion 44 are connected to the connection portion 239, which is disposed between the common wiring line 231 and the first inspection signal wiring line 235α. Accordingly, compared to a case in which the connection portion is disposed to cross the common wiring line 231 and the first inspection signal wiring line 235α, the area of the connection portion 239 is small. As a result, the likelihood of the common wiring line 231 and the first inspection signal wiring line 235α being short-circuited by the connection portion 239 that has become conductive by heating increases.

### OTHER EMBODIMENTS

The technology disclosed in this specification is not limited to the embodiments described above and illustrated in the drawings, but also includes, for example, the following embodiments within the scope of the technology.

(1) The formation area (planar shape) of the connection portions 39, 139, and 239 in plan view may be changed as appropriate and not limited to those illustrated in the drawings.

(2) The connection portions 39, 139, and 239 may be formed by a film different from the semiconductor film that forms the first semiconductor portion 24D and the second semiconductor portion 33D. In such a case, a semiconductor material different from the semiconductor film may be used as the material for the connection portions 39, 139, and 239. In addition, the material for the connection portions 39, 139, and 239 may be a material other than the semiconductor material.

(3) The number of inspection signal wiring lines 35, 135, or 235, or the number of inspection signal terminal portions 37 may be changed as appropriate and not limited to those illustrated in the drawings. In the structure according to the third embodiment, as the number of inspection signal wiring lines 35, 135, or 235 is changed, the number of connection portions 239, the number of extending portions 43 to 54, and other elements may be changed.

(4) In the structures according to the second and third embodiments, the formation area (planar shape) of the light-shielding portion 40 or 240 in plan view may be changed as appropriate and not limited to those illustrated in the drawings. For example, in the structure according to the second embodiment, the formation area of the light-shielding portion 40 in plan view may be the same as the formation area of the connection portion 139 in plan view. In addition, in the structure according to the third embodiment, a plurality of light-shielding portions 240 may be disposed to be spaced apart in the X-axis direction, similarly to the connection portions 239.

(5) In the structures according to the second and third embodiments, the material used for the light-shielding portion 40 or 240 may be a material other than the metal material. The material used for the light-shielding portion 40 or 240 may be, for example, a material that has light-shielding properties but does not have conductivity (e.g., a resin material, an inorganic material, or the like). When a material that does not have conductivity is used as the material for the light-shielding portion 40 or 240, the connection wiring line 42 may be omitted.

(6) In the structures according to the second and third embodiments, when executing the power-off sequence, the entity that outputs a signal to the light-shielding portions 40 and 240 may be, for example, an external circuit board (e.g., a control board) other than the drivers 12 and 112.

(7) In the structure according to the first embodiment, the structures of the connection portion 39, the common wiring line 31, and the inspection signal wiring line 35 may be those according to the third embodiment. In other words, the light-shielding portion 240 may be omitted from the structure according to the third embodiment.

(8) A part of the black matrix provided in the opposite substrate 20 may be disposed to overlap the connection portion 39, 139, or 239. With such a structure, the light emitted from the front side (opposite side to the backlight device side) to the connection portion 39, 139, or 239 can be blocked by the black matrix.

(9) The specific layouts of the terminal portions 32, 36, and 37 in the array substrates 21 and 121 respectively may be changed and are not limited to those illustrated in the drawings. For example, the terminal portions 32, 36, and 37 may be disposed in a row. Alternatively, the terminal portions 32, 36, and 37 may be disposed in the mounting area of the flexible substrate 13.

(10) The array substrates 21 and 121 may be provided with a switch circuit section (Source Shared Driving (SSD) circuit) that has a switch function for distributing image signals supplied from the drivers 12 and 112 to the source wiring lines 27 respectively.

(11) The display mode of the liquid crystal panel 11 may be the In Plane Switching (IPS) mode, the Twisted Nematic (TN) mode, the Vertical Alignment (VA) mode, or the like, other than the FFS mode.

(12) The liquid crystal panel 11 may be a reflective type or a semi-transmissive type other than the transmissive type.

(13) Other than the liquid crystal display device 10 that includes the liquid crystal panel 11, an organic electro luminescence (EL) display device that includes an organic EL display panel may be used.

The present disclosure contains subject matter related to that disclosed in Japanese Priority Patent Application JP 2024-159909 filed in the Japan Patent Office on Sep. 17, 2024, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A wiring substrate comprising:
a first wiring line configured to prove a common potential;
a second wiring line disposed to be spaced apart from the first wiring line; and
a connection portion connected to each of the first wiring line and the second wiring line, wherein
the connection portion comprises a material whose electrical resistance changes with temperature.

2. The wiring substrate according to claim 1, wherein the connection portion comprises a semiconductor material.

3. The wiring substrate according to claim 2, further comprising:
a light-shielding portion disposed to overlap the connection portion and configured to shield light.

4. The wiring substrate according to claim 3, further comprising:
a first insulating portion provided between the connection portion and the light-shielding portion, wherein
the light-shielding portion comprises a conductive material.

5. The wiring substrate according to claim 4, further comprising:
a signal supply unit configured to supply a signal to the light-shielding portion in accordance with an execution of a power-off sequence.

6. The wiring substrate according claim 4, further comprising:
a first switching element connected to the second wiring line; and
a third wiring line connected to the first switching element, wherein
the first switching element includes
a first electrode;
a semiconductor portion disposed to overlap the first electrode and comprising a semiconductor material;
a second insulating portion disposed between the first electrode and the semiconductor portion;
a second electrode connected to the semiconductor portion and the second wiring line; and
a third electrode disposed to be spaced apart from the second electrode and connected to the semiconductor portion and the third wiring line,
the first electrode and the light-shielding portion are parts of a first metal film,
the first insulating portion and the second insulating portion are parts of a first insulating film disposed on an upper layer side to the first metal film,
the semiconductor portion and the connection portion are parts of a semiconductor film disposed on an upper layer side to the first insulating film, and
the second electrode and the third electrode are parts of a second metal film disposed on an upper layer side to the semiconductor film.

7. The wiring substrate according to claim 3, wherein the light-shielding portion is disposed in a wider area than the connection portion in plan view.

8. The wiring substrate according to claim 1, wherein the connection portion is disposed to cross the first wiring line and the second wiring line.

9. The wiring substrate according to claim 1, wherein
the connection portion is disposed between the first wiring line and the second wiring line,
the first wiring line has a first extending portion extending toward the second wiring line side and connected to the connection portion, and
the second wiring line has a second extending portion extending toward the first wiring line side and connected to the connection portion.

10. The wiring substrate according to claim 1, further comprising:
a first inspection terminal portion connected to the second wiring line, and to which a first inspection signal is input;
a plurality of first switching elements connected to the second wiring line;
a plurality of third wiring lines connected to the plurality of first switching elements;
a plurality of second switching elements connected to the plurality of third wiring lines; and
a plurality of first pixel electrodes connected to the plurality of second switching elements.

11. The wiring substrate according to claim 10, further comprising:
a fourth wiring line disposed to be spaced apart from the first wiring line or the second wiring line;
a second inspection terminal portion connected to the fourth wiring line, and to which a second inspection signal having a polarity reversed from the polarity of the first inspection signal is input;
a plurality of third switching elements connected to the fourth wiring line;
a plurality of fifth wiring lines connected to the plurality of third switching elements;
a plurality of fourth switching elements connected to the plurality of fifth wiring lines; and
a plurality of second pixel electrodes connected to the plurality of fourth switching elements, wherein
the connection portion is connected to the fourth wiring line.

12. The wiring substrate according to claim 1, wherein the connection portion is configured to become non-conductive at an upper limit of expected ambient temperature and become conductive at a first temperature that is higher than the upper limit.

13. A display device comprising:
the wiring substrate according to claim 1; and
an opposite substrate disposed to face the wiring substrate with a space therebetween.

14. A method of manufacturing a wiring substrate comprising:
providing a first wiring line configured to prove a common potential,
a second wiring line disposed to be spaced apart from the first wiring line, and
a connection portion connected to each of the first wiring line and the second wiring line, the connection portion comprising a material whose electrical resistance changes with temperature, and
performing an annealing process to lower the resistance of the connection portion.
